(19) United States
(12) Patent Application Publication
(10) Pub. No.: US 2019/0227677 A1
(43) Pub. Date: Jul. 25, 2019

(54) INPUT DISPLAY APPARATUS, INPUT DISPLAY METHOD, AND RECORDING MEDIUM ON WHICH INPUT DISPLAY PROGRAM IS STORED

(71) Applicant: SHARP KABUSHIKI KAISHA, Osaka (JP)

(72) Inventor: HIROKI MUNETOMO, Sakai City (JP)

(21) Appl. No.: 16/252,222

(22) Filed: Jan. 18, 2019

(30) Foreign Application Priority Data
Jan. 23, 2018 (JP) 2018-008936

(51) Int. Cl. G06F 3/0482; G06F 3/0484; G06F 3/0488

(52) U.S. Cl. CPC G06F 3/0482; G06F 2203/04808; G06F 3/04883; G06F 3/0484

(57) ABSTRACT

An input display apparatus includes a display unit which has a display screen on which multiple items of content are displayed. An input operation is possibly performed on the display screen. The input display apparatus includes a detection unit that detects selection of first content, and a display processing unit that causes an attribute of an object to be dependent on an attribute of content, in a case where an operation of moving a selected object onto the content is detected.

### BACKGROUND

### 1. Field

The present disclosure relates to an input display apparatus and particularly to an input display apparatus that includes a display unit, such as a touch panel, which has a display screen on which content or an object is displayed and in which an input operation is performed by a user on the display screen, an input display method, and a recording medium on which an input display program is stored.

### 2. Description of the Related Art

In the related art, it is known that, in a case where there are present multiple users who use an input display apparatus such as a table type touch display, when content is displayed such as an image or a document, the content (a sheet) is rotated at an arbitrary angle toward each of the users, thereby being displayed.

In the table type touch display, when multiple users attend a meeting or the like, there is a need to display document data in each of the users. However, in a case where one user adds an electronically hand-written memo onto a material that is displayed toward a counterpart user who faces the one user between the table type display in between, it is difficult to write down a memo toward the direction of the counterpart user who faces the one use. Furthermore, if one user first writes down a memo in the direction of the one user and then rotates the memo toward the counterpart user who faces the one user, there occurs a problem in that an operation is troublesome.

Thus, in the related art, for example, it is proposed that, in the information input display apparatus, if an attribute of an original document information (content) that is displayed is the same as an attribute of input information (an object), directions of the original document information and the input information are caused to be the same and thus the original document information and the input information are rotated, thereby being displayed (Japanese Unexamined Patent Application Publication No. 2015-61157).

Thus, as another technology in the related art, it is proposed that, in the information processing apparatus, in a case where a display unit is divided for an area that is to be occupied by the user and the area is used, when content or an object is dragged or is slowly moved from any other area to a user-occupied area in accordance with a user, rotation processing is performed, in a direction that is opposite the user, on the content or the object, thereby displaying the content or the object (Japanese Unexamined Patent Application Publication No. 2013-145468).

However, a problem with the technology that is proposed in Japanese Unexamined Patent Application Publication No. 2015-61157 is that when input is completed, because rotation is immediately is performed, an operator has difficulty in performing rotation at an intended timing. Because a tablet terminal is assumed in Japanese Unexamined Patent Application Publication No. 2015-61157, this does not assume a situation for using a fixed display apparatus, where for viewing, multiple persons surround the fixed display apparatus such as a table display. Because of this, which angle an original document that has to be served as a reference for an automatic rotation angle is displayed at is not described. In the technology that is proposed in Japanese Unexamined Patent Application Publication No. 2013-145468, there is a need to move the object to the area of the counterpart user in order to cause the object to face the direction of the counterpart user. Because of this, particularly, in a case where the size of a display is large, there is a problem in that an operation is troublesome. In Japanese Unexamined Patent Application Publication No. 2013-145468, an angle for automatic rotation is fixed based on the area. Because of this, there is a problem in which in some cases, the object is rotated without control against the intention of the operator, or in other cases, the object is automatically rotated at an angle that is not intended by the operator.

It is desirable to provide an input display apparatus, an input display method, and an input display program that are capable of easily displaying an added object on content that is displayed in alignment with a direction of a counterpart user, in alignment with the direction of the counterpart user, without performing a troublesome operation, and thus are capable of achieving an improvement in operability.

### SUMMARY

According to an aspect of the present disclosure, there is provided an input display apparatus that possibly displays content, including: a display unit on which multiple items of content are displayed; a detection unit that detects an operation on first content among the multiple items of content that are displayed on the display unit; and a display processing unit that causes an attribute of the first content to be dependent on an attribute of second content, in a case where an operation of moving or adding the first content onto the second content is detected by the detection unit.

According to another aspect of the present disclosure, there is provided an input display method in an input display apparatus that possibly displays content, the method including: displaying multiple items of content; detecting an operation on first content among the multiple items of content that are displayed; and performing display processing that causes an attribute of the first content to be dependent on an attribute of second content, in a case where an operation of moving or adding the first content onto the second content is detected.

According to still another aspect of the present disclosure, there is a non-transient recording medium on which a program that causes an input display apparatus which possibly displays content to operate is stored, the program causing a computer to: display multiple items of content; detect an operation on first content among the multiple items of content that are displayed; and perform display processing that causes an attribute of the first content to be dependent on an attribute of second content, in a case where an operation of moving or adding the first content onto the second content is detected.

### BRIEF DESCRIPTION OF THE DRAWINGS

FIG. 1 is a descriptive diagram illustrating a configuration of an input display apparatus according to a first embodiment of the present technology, which is an implementation example of the disclosure;

FIG. 2 is a block diagram illustrating a schematic configuration of the input display apparatus;

FIG. 3 is a descriptive diagram illustrating an example of a relationship between a location of each of two users with respect to a display screen in the input display apparatus and a display direction of content that is displayed on the display screen;

FIG. 4 is a descriptive diagram illustrating a state where the content is display-controlled (rotated by 180° and thus displayed) on the display screen;

FIG. 5 is a descriptive diagram illustrating a state where a user writes an object on the display screen in the input display apparatus;

FIG. 6 is a descriptive diagram illustrating a state where the object is moved onto the content on the display screen;

FIG. 7 a descriptive diagram illustrating a state where the object is display-controlled (rotated by 180° and thus displayed) on the content on the display screen;

FIG. 8 is a flowchart illustrating a part of a procedure for the display control in which an attribute of the object that is displayed on the display screen in the input display apparatus is caused to be the same as an attribute of the content and the object is displayed;

FIG. 9 is a flowchart illustrating a part of the procedure for the display control that continues from the flowchart in FIG. 8;

FIG. 10 is a flowchart illustrating a part of the procedure for the display control that continues from the flowchart in FIG. 9;

FIG. 11 is a descriptive diagram illustrating a relationship between a rotation angle of the content, which is displayed on the display screen in the input display apparatus, and a direction of the user;

FIG. 12 is a descriptive diagram illustrating an example of a modification example in which an image is superimposed onto the content that is display-controlled (rotated by 180° and thus displayed) on the display screen in the input display apparatus;

FIG. 13 is a descriptive diagram illustrating a state where the image is positioned on the content;

FIG. 14 is a descriptive diagram illustrating a state where the image that is positioned on the content is display-controlled (rotated by 180° and thus displayed);

FIG. 15 is a descriptive diagram illustrating an example of a state where an object is written on content that is display-controlled (rotated by 180° and thus displayed) on a display screen in an input display apparatus according to a second embodiment;

FIG. 16 is a descriptive diagram illustrating a state where the object that is written on the content is display-controlled (rotated by 180° and thus displayed);

FIG. 17 is a flowchart illustrating a part of a procedure for the display control in which an attribute of the object that is displayed on the display screen is caused to be the same as an attribute of the content and the object is displayed;

FIG. 18 is a flowchart illustrating a part of the procedure for the display control that continues from the flowchart in FIG. 17;

FIG. 19 is a flowchart illustrating a part of the procedure for the display control that continues from the flowchart in FIG. 18;

FIG. 20 is a descriptive diagram illustrating an example in which multiple items of content that are display-controlled on a display screen in an input display apparatus according to a third embodiment and an object are displayed;

FIG. 21 is a descriptive diagram illustrating a state where an object is separated from an area for displaying content B, among the multiple items of content, and the object is moved to an area other than the area for displaying the content B;

FIG. 22 is a descriptive diagram illustrating a state where the object is moved to an area for displaying content A;

FIG. 23 is a descriptive diagram illustrating a state where the object is display-controlled on the area for displaying the content A;

FIG. 24 is a descriptive diagram illustrating an example in which content that is display-controlled on a display screen in an input display apparatus according to a fourth embodiment and an object that is superimposed on the content are composited and a result of the compositing is displayed;

FIG. 25 is a diagram illustrating an example in which an operation of rotating the content that is compositely combined with the object is performed and thus the result of the compositing is displayed;

FIG. 26 is a descriptive diagram illustrating an example in which content that is display-controlled on a display screen in an input display apparatus according to a fifth embodiment and an object on an area for displaying the content are displayed;

FIG. 27 is a descriptive diagram illustrating a state where the object that is displayed on the area for displaying the content is separated from the content and thus is displayed;

FIG. 28 is a descriptive diagram illustrating an example in which content that is display-controlled on a display screen in an input display apparatus according to a sixth embodiment and an object on an area for displaying the content are displayed;

FIG. 29 is a descriptive diagram illustrating a state where the object that is displayed on the area for displaying the content is separated from the content and thus is displayed;

FIG. 30 is a descriptive diagram illustrating a state where the user writes an object on a display screen in an input display apparatus according to a seventh embodiment;

FIG. 31 is a descriptive diagram illustrating a state where the object is moved onto content on the display screen;

FIG. 32 is a descriptive diagram illustrating a state where the user writes an object on a display screen in an input display apparatus according to a ninth embodiment; and

FIG. 33 is a descriptive diagram illustrating a state where, on the display screen, an attribute of the object is caused to be dependent on an attribute of content and thus the object is displayed in an enlarged manner.

### DESCRIPTION OF THE EMBODIMENTS

### First Embodiment

A first embodiment of the present disclosure will be described below with reference to the drawings.

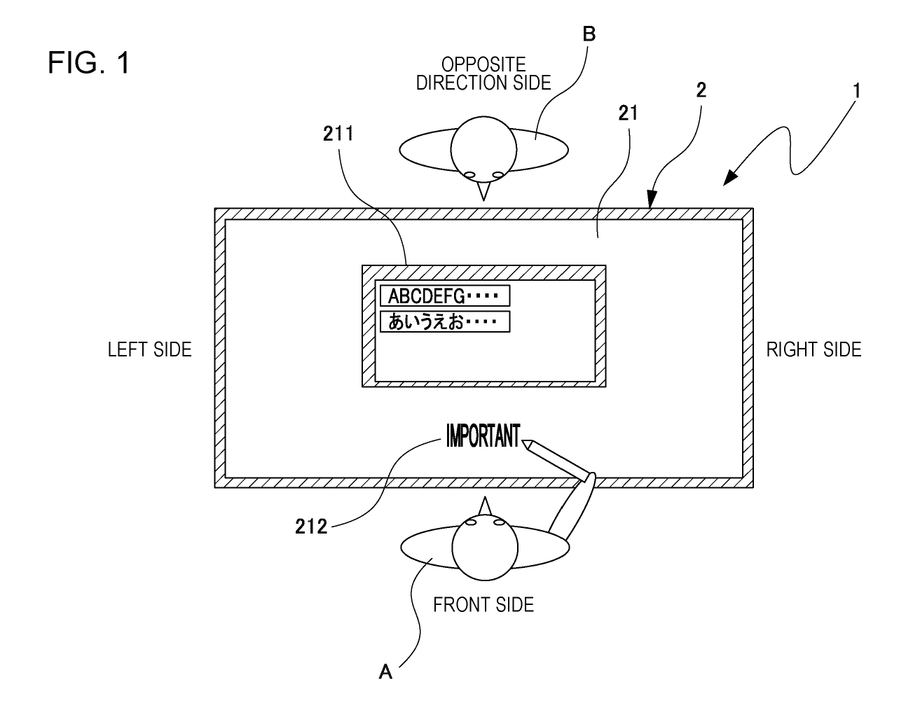

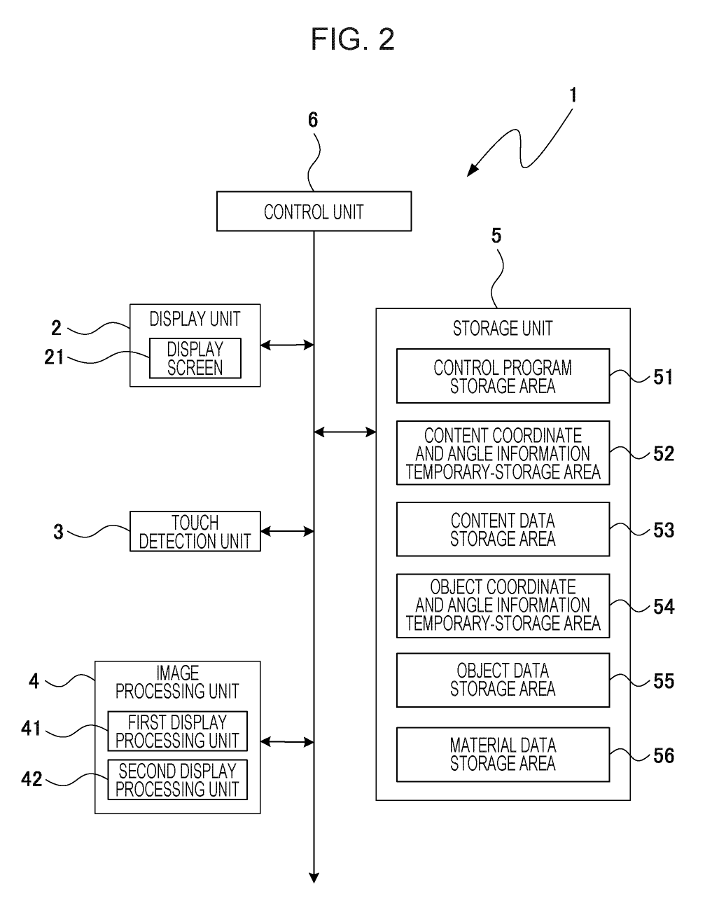

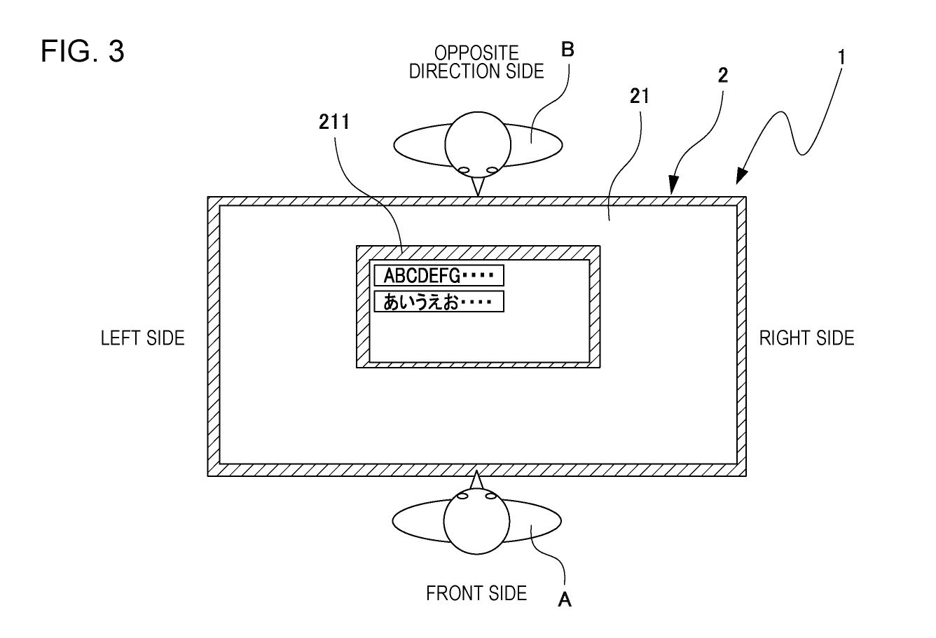

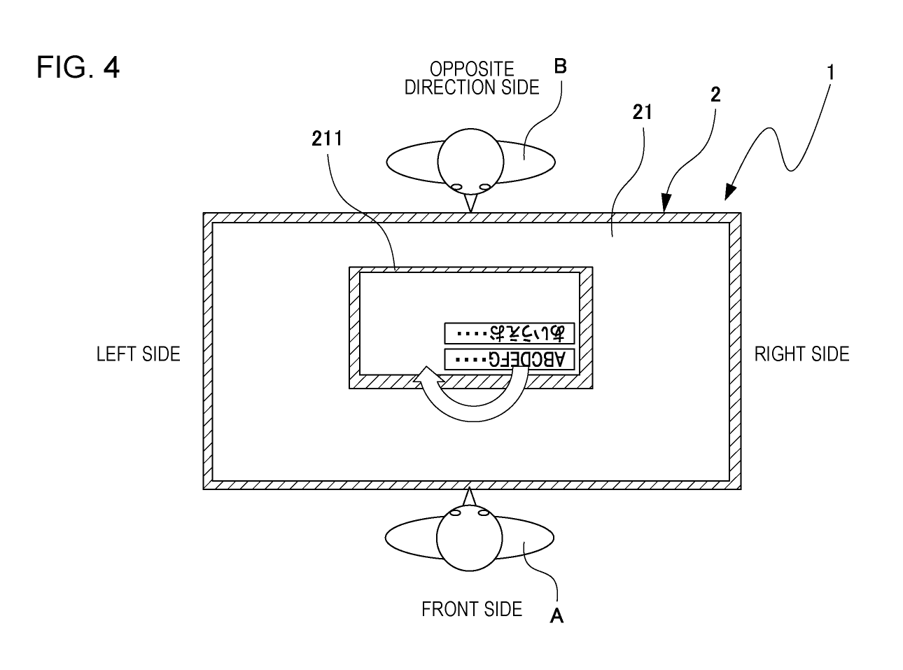

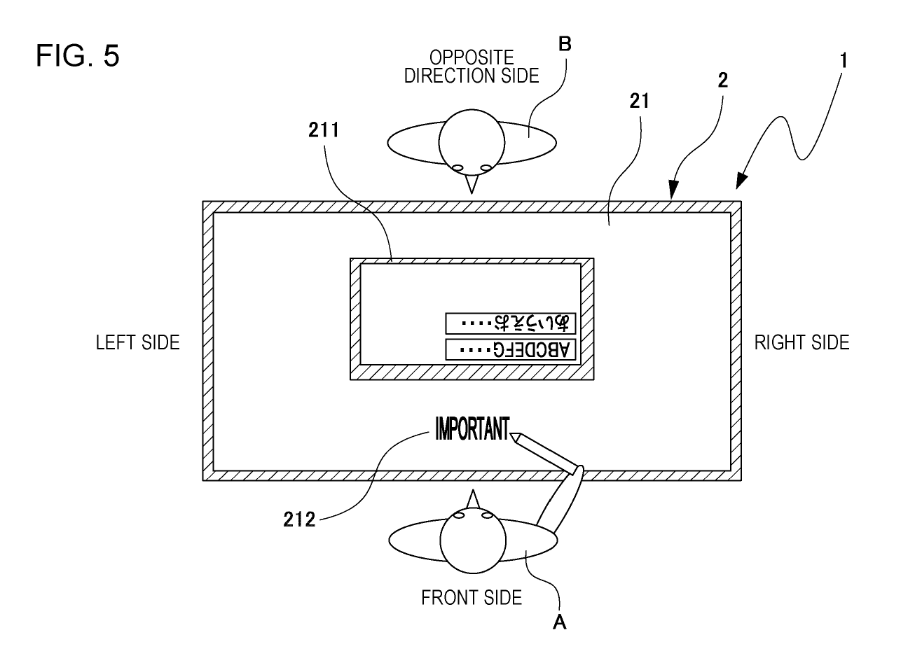

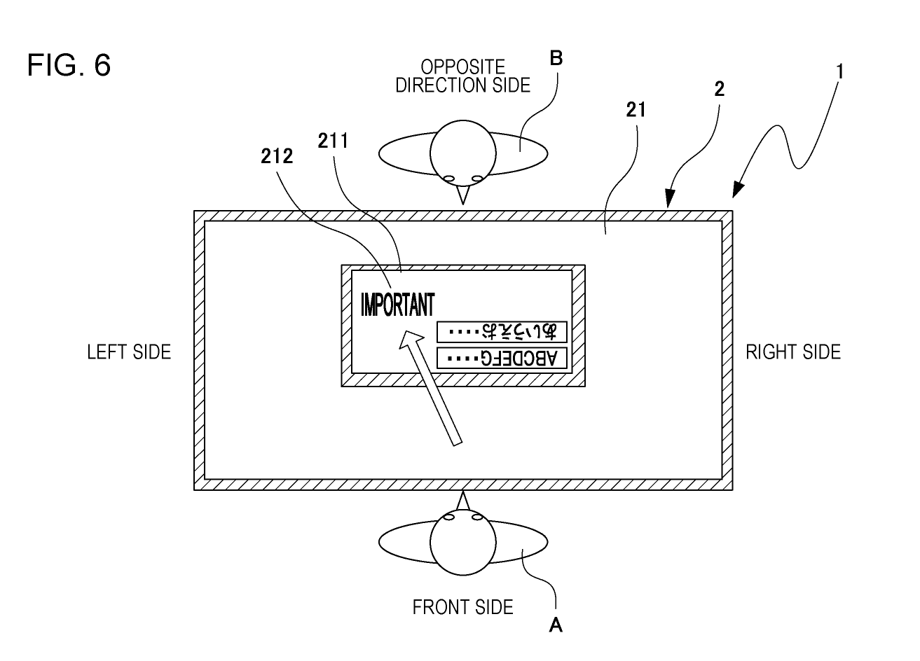

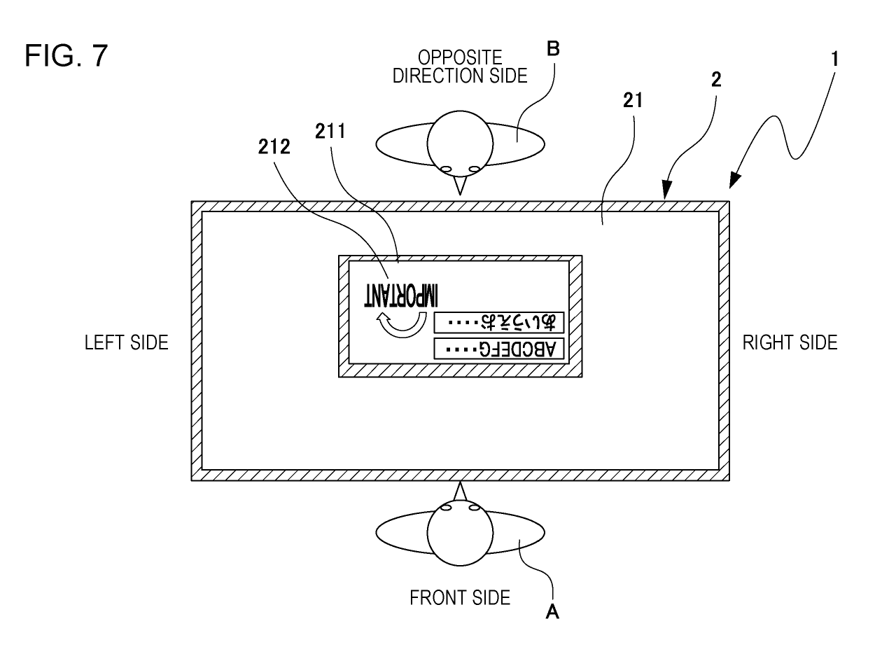

FIG. 1 is a descriptive diagram illustrating a configuration of an input display apparatus according to the first embodiment of the present disclosure, which is an implementation example of the disclosure. FIG. 2 is a block diagram illustrating a schematic configuration of the input display apparatus. FIG. 3 is a descriptive diagram illustrating an example of a relationship between a location of each of two users with respect to a display screen in the input display apparatus and a display direction of content that is displayed on the display screen. FIG. 4 is a descriptive diagram illustrating a state where the content is display-controlled (rotated by 180° and thus displayed) on the display screen. FIG. 5 is a descriptive diagram illustrating a state where the user writes an object on the display screen in the input display apparatus. FIG. 6 is a descriptive diagram illustrating a state where the object is moved onto the content on the display screen. FIG. 7 a descriptive diagram illustrating a state where the object is display-controlled (rotated by 180° and thus displayed) on the content on the display screen.

### Configuration of the Input Display Apparatus

An input display apparatus 1 according to the first embodiment, as illustrated in FIG. 1, includes a display unit 2 that has a display screen 21 on which content (second content) 211 and an object (first content) 212 are displayed. In the input display apparatus 1 in which the user possibly performs an input operation on a display screen 21, in a case where the selected object 212 is moved onto the content 211, an attribute of the object 212 is caused to be dependent on an attribute of the content 211.

The input display apparatus 1, as illustrated in FIG. 2, is configured to include a display unit 2, a touch detection unit 3, an image processing unit 4, a storage unit 5, and a control unit 6.

The touch detection unit (selection means) 3 detects an amount of operation of gesturing toward the content 211 and the object 212 that are displayed on the display screen 21, for example, an amount of operation in each of the moving direction the rotating direction, or the like. In the first embodiment, the touch detection unit 3 is configured in such a manner as to function the selection means that selects the object 212.

The image processing unit 4 includes a first display processing unit (first display processing means) 41 that displays the content 211 on the display screen 21 based on the operation of gesturing by the user on the display screen 21, and a second display processing unit (second display processing means) 42 that displays the object 212 on the display screen 21 based on the operation of gesturing.

The second display processing unit 42 has a function in which, when the object 212 is moved onto the content 211 that is displayed on the display screen 21, thereby being displayed, an attribute (a rotation angle) for displaying the object 212 is caused to be dependent on the attribute of the content 211, that is, to be the same as the attribute (the rotation angle) for displaying the content 211 and in which the object 212 is thus displayed.

The storage unit 5 includes a control program storage area 51, a content coordinate and angle information temporary-storage area 52, a content data storage area 53, an object coordinate and angle information temporary-storage area 54, an object data storage area 55, and a material data storage area 56.

In the first embodiment, as illustrated in FIG. 1, an example is given where the input display apparatus 1 is caused to function as a table for a meeting and where two users, that is, users A and B, who face each other, located in the vicinity of the input display apparatus 1.

At this point, a location of the user A who is a master is defined as being on the front side, and a location of the user B, that is, any other attendee who faces the user A, is defined as being on the opposite direction side. In the input display apparatus 1, the display control is performed in such a manner that the display screen 21 is in a position direction with respect of the location of the user A.

That is, in the input display apparatus 1, the content 211 and the object 212 are displayed on the display screen 21 are displayed toward the positive direction with respect to the user A who is the master.

### Display Operation on the Display Screen

Next, a case where in the input display apparatus 1 according to the first embodiment, the content 211 and the object 212 are displayed will be described with reference to the drawings.

In FIG. 3, a state where the user A displays the content 211.

The content 211 is displayed in a direction that is opposite the user A. At this time, the content 211 has an attribute that is a content rotation angle of 0°.

In a case where the content 211 is displayed, in an easy-to-view direction, toward the user B on the opposite direction side to view, as illustrated in FIG. 4, the operation of gesturing for the rotation by 180° on the display screen 21 is performed on the content 211. As a result, because a function of the first display processing unit 41, control is performed in such a manner that the content 211 is rotated by 180° and thus is displayed in a direction that is opposite the user B. At this time, the content 211 has an attribute that is the content rotation angle of 180°.

In FIG. 5, the object 212 that is a string of letters “important” is input by the user A into an area other than the content 211, of the display screen 21.

The object 212 is drawn in the direction that is opposite the user A. At this time, the object 212 has an attribute that is an object rotation angle of 0°.

When as illustrated in FIG. 6, for positioning, the object 212 is moved onto the content 211 that is displayed in the direction that is opposite the user B, as illustrated in FIG. 7, because of a function of the second display processing unit 42, control is performed in such a manner that the object 212 is rotated by 180° with an attribute that is the same as the attribute of the content 211 and thus is displayed in the direction that is opposite the user B. At this time, an object rotation angle β, which is the attribute of the object 212, is changed from 00 to 180°.

Next, a procedure for the display control in the input display apparatus 1 according to the first embodiment, in which, for positioning, the object is moved onto the content that is displayed on the display screen 21 and, thus the attribute of the object is caused to be the same as an attribute of the content and the object is displayed, will be described with reference to a flowchart.

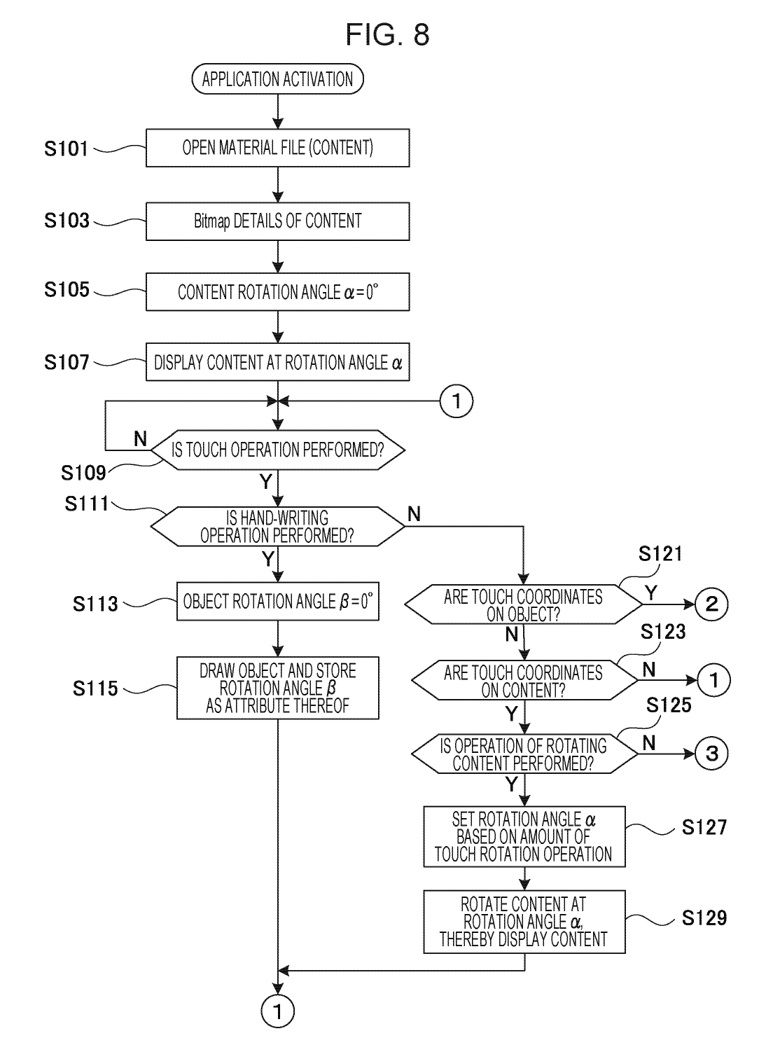

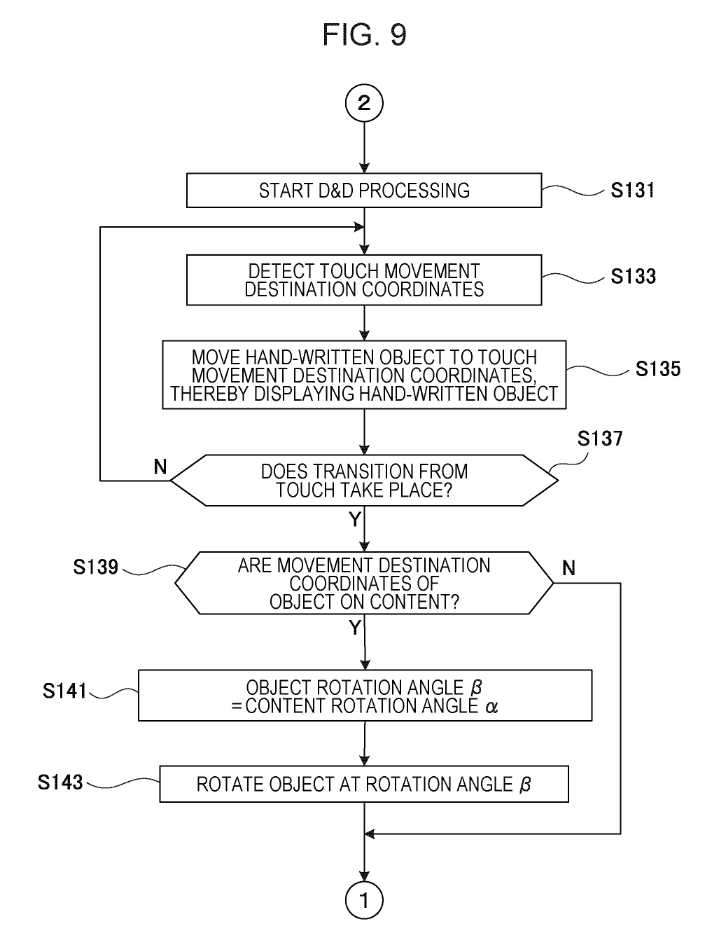

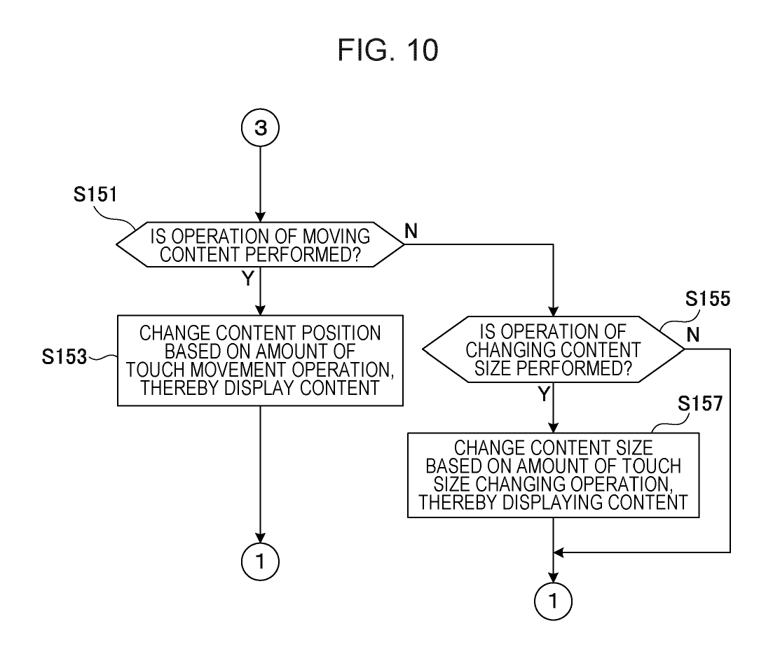

FIG. 8 is a flowchart illustrating a part of the procedure for the display control in which the attribute of the object that is displayed on the display screen in the input display apparatus according to the first embodiment is caused to be the same as the attribute of the content and the object is displayed. FIG. 9 is a flowchart illustrating a part of the procedure for the display control that continues from the flowchart in FIG. 8. FIG. 10 is a flowchart illustrating a part of the procedure for the display control that continues from the flowchart in FIG. 9.

In the input display apparatus 1, as illustrated in FIG. 8, an application that performs the display control is activated, and thus a specified documentary-material file (hereinafter referred to “content”) is opened (Step S101) and contents thereof are bitmapped, thereby being displayed on the display screen 21 (Step S103).

A content rotation angle α that is a rotation angle attribute of the content is set to 0° (Step S105), and the content is displayed at a rotation angle of 0° on the display screen 21 (Step S107). Then, it is determined whether or not the operation of gesturing including a touch operation is performed on the display screen (Step S109).

In a case where it is determined in Step S109 that the touch operation (the operation of gesturing) is performed on the display screen, it is determined whether or not the operation is a handwriting operation (Step S111).

In a case where it is determined in Step S111 that the writing operation is performed, an object rotation angle β of the handwritten object (hereinafter referred to “object”) is set to 0° (Step S113), the object is drawn, and the object rotation angle β is stored as the attribute of the object (Step S115). Then, returning to Step S109 takes place, and it is consecutively determined whether or not the touch operation is performed.

On the other hand, in a case where it is determined in Step S111 that the handwriting operation is not performed, proceeding to Step S121 takes place, and it is determined whether or not position coordinates at which the touch operation is performed are on the object.

In a case where it is determined in Step S121 that the position coordinates at which the touch operation is performed are not on the object, it is determined whether or not the position coordinates at which the touch operation is performed are on the content (Step S123).

In a case where it is determined in Step S123 that the position coordinates at which the touch operation is performed is on the content, it is determined whether or not the touch operation is a touch operation of rotating the content (Step S125).

In a case where it is determined in Step S125 that the touch operation is the operation of rotating the content, the content rotation angle α is set based on an amount of rotation operation due to the touch operation (hereinafter referred to “amount of touch rotation operation”) (Step S127), and the content is rotated by the rotation angle α, thereby being displayed (Step S129). Then, the returning to Step S109 takes place, and it is consecutively determined whether or not the touch operation is performed on the display screen.

In a case where it is determined in Step S121 that the position coordinates at which the touch operation is performed are on the object, as illustrated in FIG. 9, proceeding to Step S131 takes place, and a drag & drop processing is started. Thus, touch movement destination coordinates are detected (Step S133) and the object is moved to the touch movement destination coordinates, thereby being displayed (Step S135). Then, it is determined whether or not a transition from a touch state in the touch operation takes place (Step S137).

In a case where it is determined in Step S137 that the transition from the touch state takes place, it is determined whether or not movement destination coordinates of the object is on the content (Step S139).

In a case where it is determined in Step S139 that the movement destination coordinates of the object are on the content, the object rotation angle β is set to be the same as the content rotation angle α (Step S141) and the object is rotated in such a manner as to be the object rotation angle β (Step S143). Then, the returning to Step S109 takes place and it is continuously determined whether or not the touch operation is performed on the display screen.

In a case where it is determined in Step S139 that the movement destination coordinates of the object are not on the content, the returning to Step S109 takes place.

On the other hand, in a case where it is determined in Step S137 that the transition from the touch state does not take place, returning to Step S133 and the touch movement destination coordinates is again detected.

In a case where it is determined in Step S123 that the position coordinates at which the touch operation is performed are not on the content, the returning to Step S109 and it is continuously determined whether or not the touch operation is performed on the display screen.

In a case where it is determined in Step S125 that the touch operation of rotating the content is not performed, as illustrated in FIG. 10, it is determined whether or not the touch operation is an operation of moving the content (Step S151).

In a case where it is determined in Step S151 that the touch operation is the operation of moving the content, a content position is changed based on an amount of touch movement operation, thereby being displayed (Step S153). Then, the returning to Step S109 takes place, and it is consecutively determined whether or not the touch operation is performed on the display screen.

On the other hand, in a case where it is determined in Step S151 that the touch operation is not the operation of moving the content, proceeding to Step S155 takes place and it is determined whether or not the touch operation is an operation of changing a content size.

In a case where it is determined in Step S155 that the touch operation is the operation of changing the content size, the content size is changed based on the operation of changing the touch size, thereby being displayed (Step S157). Then, the returning to Step S109 takes place, and it is consecutively determined whether or not the touch operation is performed on the content.

On the other hand, in a case where it is determined in Step S155 that the touch operation is not the operation of changing the content size, the returning to Step S109, and it is continuously determined whether or not the touch operation is performed on the display screen.

In this manner, in the input display apparatus 1 for the object, with the touch operation (the operation of gesturing), the content and the object that are displayed on the display screen 21 are rotated and are moved and thus may be displayed in a direction in which it is easy for any other user to view the content and the object.

In the first embodiment, when the object 212 is moved onto the content 211 that is displayed on the display screen 21, the attribute of the object 212 is caused to be the same as the attribute of the content 211, and thus, only by moving the object 212 onto the content 211, the object 212 can be displayed in the same direction as the content 211 is displayed.

At this point, an example, a displayed state of the object in a case where the attribute of the content that is displayed on the display screen 21 of the input display apparatus 1 according to the first embodiment is set to be the rotation angle is described.

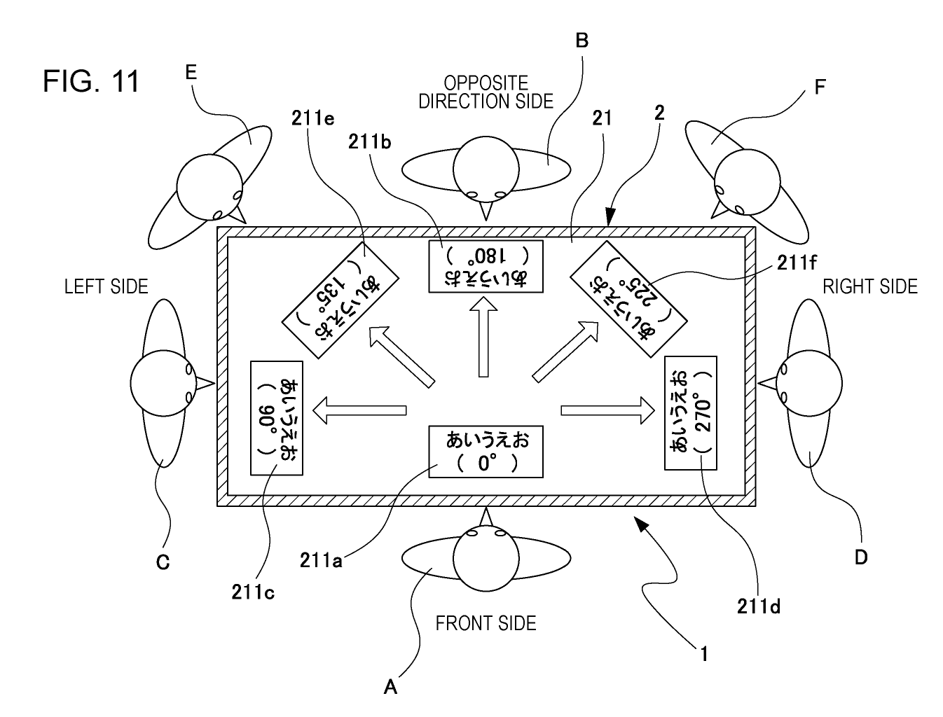

FIG. 11 is a descriptive diagram illustrating a relationship between a rotation angle of the content, which is displayed on the display screen in the input display apparatus according to the first embodiment, and a direction of the user.

In the input display apparatus 1, as illustrated in FIG. 11, in a case where the content is displayed to multiple users, for example, users A, B, C, D, E and F, the content is caused to have the attribute that is the content rotation angle α, in a manner that corresponds to a direction in which the user faces the input display apparatus 1, and thus the content is displayed in a manner that corresponds to each of the users.

A relationship between a direction of each of the users A, B, C, D, E, and F who face the input display apparatus 1, and a direction of the content is as illustrated in FIG. 11. When a direction in which the user A who is located on the front side faces the input display apparatus 1 is set to be at a rotation angle of 0°, a content rotation angle α of content 211a is 0°. When a direction of the user B on the opposite direction side is set to be at a rotation angle of 180°, a content rotation angle α of content 211b is 180°. When a direction of the user C on the left side is set to be at a rotation angle of 90°, a content rotation angle α of content 211c is 90°. When a direction of the user D on the right side is set to be at a rotation angle of 270°, a content rotation angle α of content 211d is 270°. When a direction of the user E on the inclined left side is set to be at a rotation angle of 135°, a content rotation angle α of content 211e is 135°. When a direction of the user F on the inclined left side is set to be at a rotation angle of 225°, a content rotation angle α of content 211f is 225°. In this manner, the content can be positioned in a manner that corresponds to each of the users.

Since the configuration described above is employed, according to the first embodiment, the input display apparatus 1, which is configured as described above, includes the touch detection unit 3 that selects the object 212, the first display processing unit 41 that moves the selected object 212, and the second display processing unit 42 that causes the attribute of the object 212 to be dependent on the attribute of the content 211 in a case where the object 212 is moved onto the content 211. Thus, the object 212 that is added is positioned on the content 211 that is displayed in a manner that is aligned with the direction of a counterpart user, without performing a troublesome operation. As a result, the attribute of the object 212 is caused to be the same as the attribute of the content 211, and thus the object 212 can be rotated in a direction that is the same as a direction of the content 211 that is displayed in a manner that is automatically aligned with the direction of the counterpart user, thereby being displayed.

### Modification Examples

In the first embodiment, the object 212 that is handwritten on the content 211 which is displayed on the display screen 21 is set to be moved for positioning, but the object is not limited to being handwritten. Although as a modification example, an image or text is set to be added onto the content 211, it is possible that the same processing is performed.

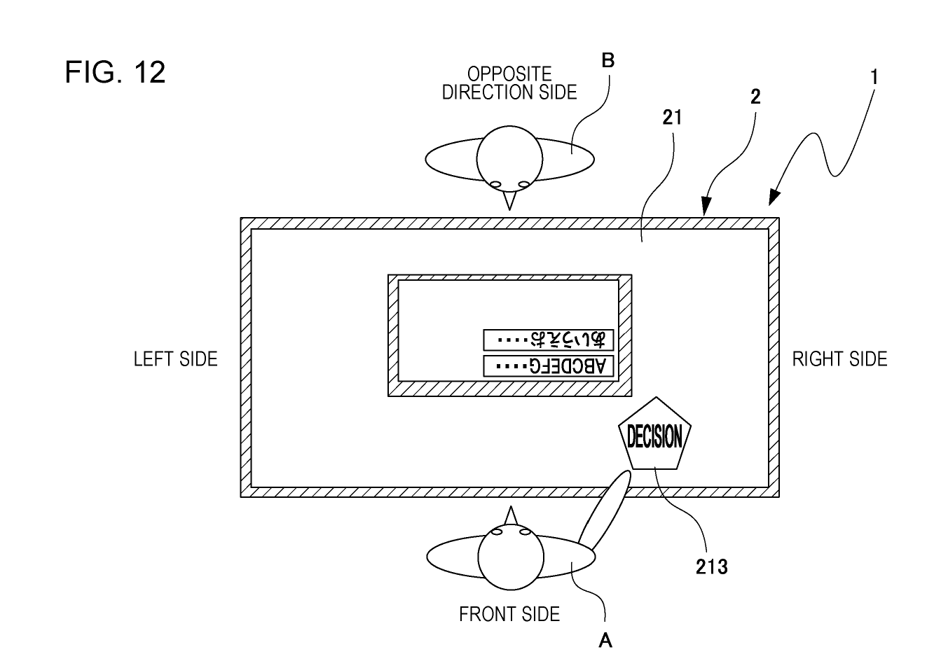

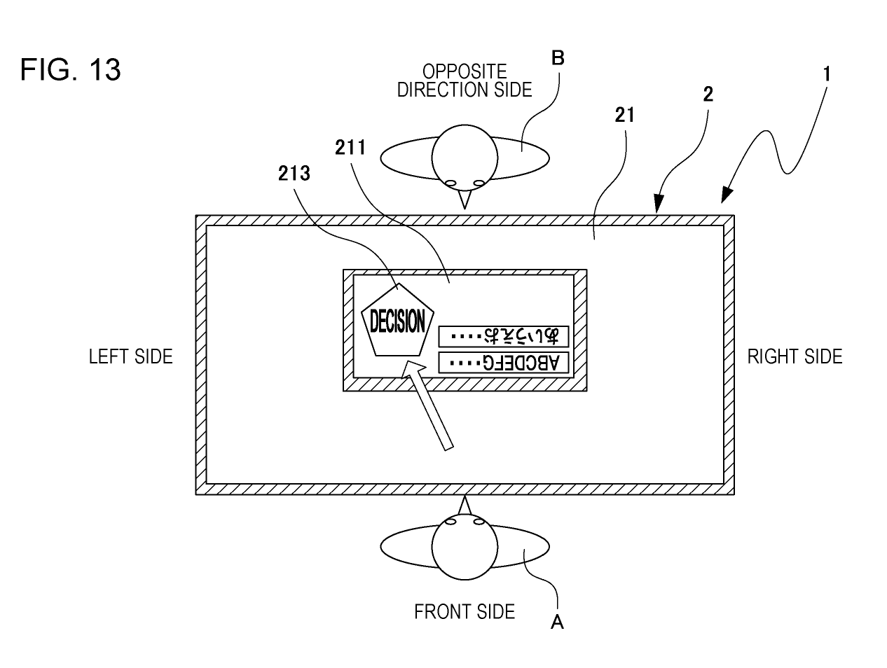

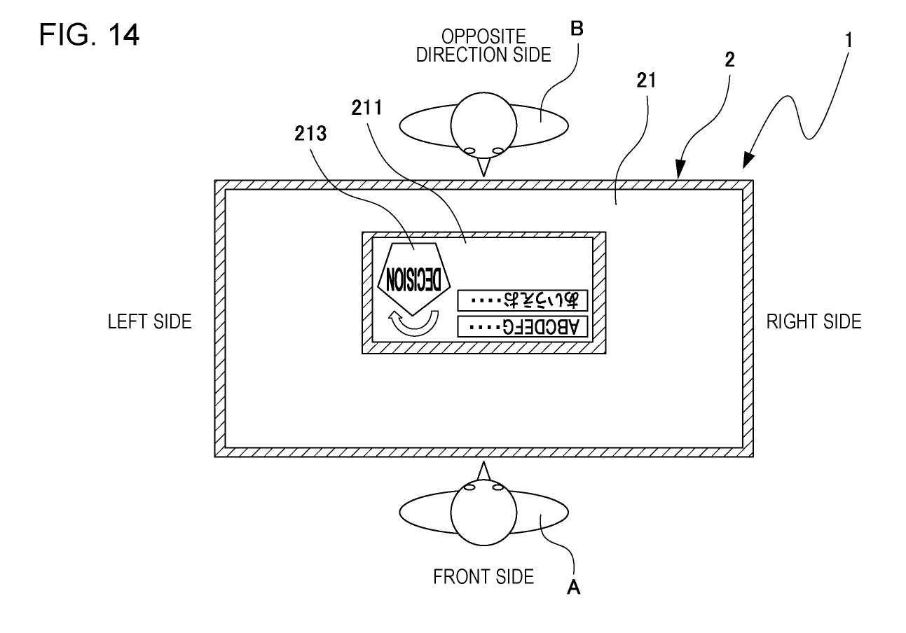

FIG. 12 is a descriptive diagram illustrating an example of the modification example in which an image is superimposed onto the content that is display-controlled (rotated by 180° and thus displayed) on the display screen in the input display apparatus according to the first embodiment. FIG. 13 is a descriptive diagram illustrating a state where an image is positioned on the content. FIG. 14 is a descriptive diagram illustrating a state where the image that is positioned on the content is display-controlled (rotated by 180° and thus displayed).

In FIG. 12, an image 213 is input by the user A.

The image 213 is drawn in the direction that is opposite the user A. At this time, the image 213 has an attribute that is an image rotation angle θ which is set to 0°.

When as illustrated in FIG. 13, for positioning, the image 213 is moved onto the content 211 that is displayed in the direction that is opposite the user B, as illustrated in FIG. 14, because of the function of the second display processing unit 42, control is performed in such a manner that the image 213 is rotated by 180° with an attribute that is the same as the attribute of the content 211 and thus is displayed in the direction that is opposite the user B. At this time, the image rotation angle that is an attribute of the image 213 is changed from 0° to 180°.

In this manner, when the image 213 is superimposed onto the content 211 that is displayed on the display screen 21, the attribute of the image 213 is caused to be the same as the attribute of the content 211. Thus, only by moving the image 213 onto the content 211, the image 213 can be displayed in the same direction as the content 211 is displayed.

It is noted that in the first embodiment, the image of letters that are handwritten is displayed as the object, but that an object that results for letter-recognizing the handwritten letters and converting the recognized letters into text may be instead displayed and be rotated.

### Second Embodiment

Next, a second embodiment will be described with reference to the drawings.

It is noted that for the convenience of description, a configuration that has the same function as in the first embodiment is given the same reference numeral and a description thereof is omitted.

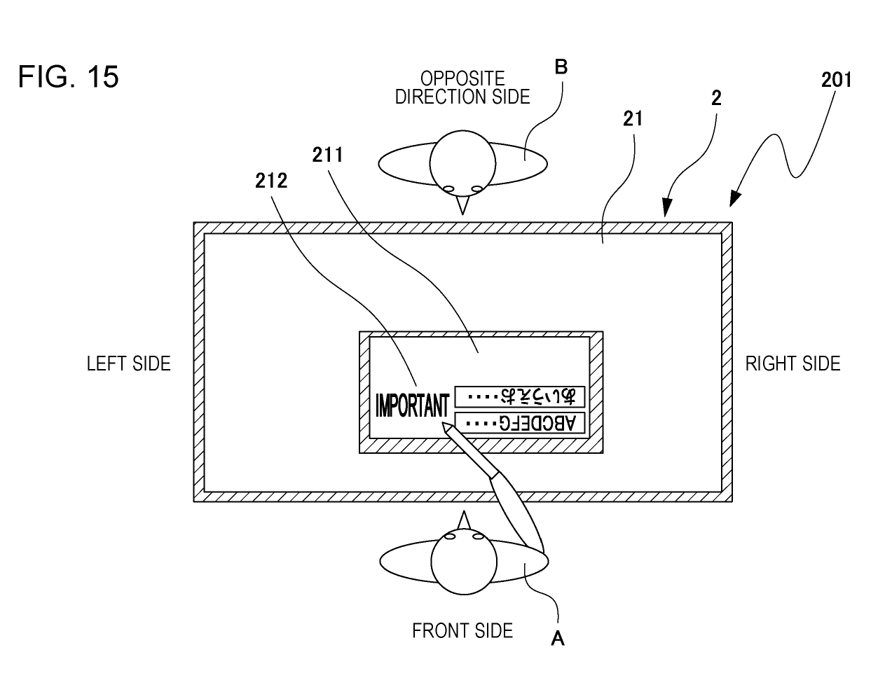

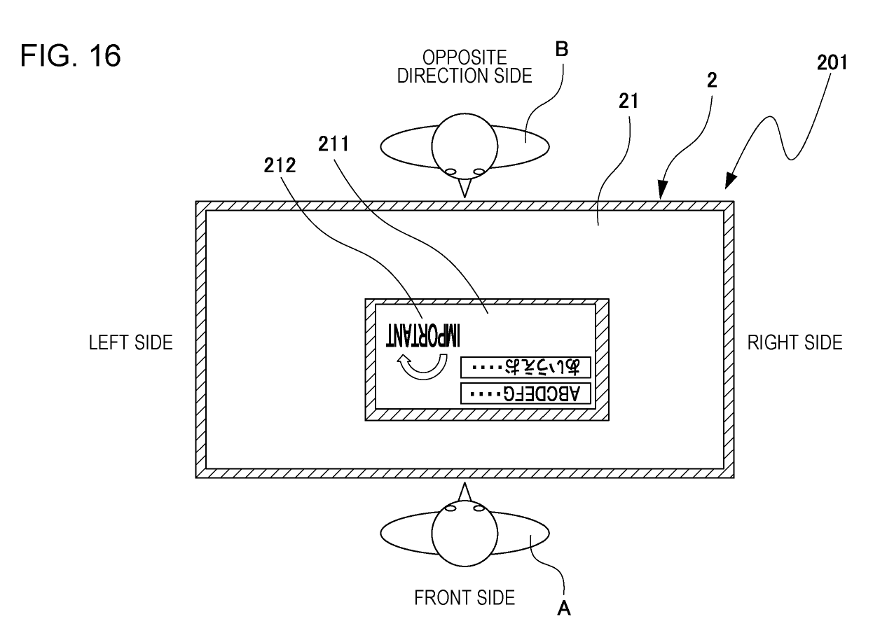

FIG. 15 is a descriptive diagram illustrating an example of a state where an object is written on content that is display-controlled (rotated by 180° and thus displayed) on a display screen in an input display apparatus according to the second embodiment. FIG. 16 is a descriptive diagram illustrating a state where the object that is written on the content is display-controlled (rotated by 180° and thus displayed).

When, as the function of the second display processing unit 42, the object is added onto the content that is displayed on the display screen 21 and thus is displayed, the input display apparatus 201 according to the second embodiment causes an attribute for displaying the object to be the same as an attribute for displaying the content, and thus displays the object.

In FIG. 15, a state is illustrated where the user A adds the object 212 onto the content 211 that is displayed on the display screen 21.

The content 211 is displayed in the direction that is opposite the user B on the opposite direction side. At this time, the content 211 has an attribute that is the content rotation angle α which is set to 180°.

The object 212 that is added by the user A is drawn in the direction that is opposite the user A. The object 212 that is added has an attribute that is the object rotation angle β which is set to 0°.

Because of the function of the second display processing unit 42, the attribute of the object 212 that is added onto the content 211 is caused to be the same as the attribute for displaying the content 211 and the object 212 is displayed on the content 211.

That is, when the drawing is ended, as illustrated in FIG. 16, the object rotation angle β that is the attribute of the object 212 is changed to 180 in the same manner as the content rotation angle α of the content 211, and is rotated from the direction that is opposite the user A to a direction that is opposite the user B on the opposite direction side, thereby being displayed.

Next, a procedure for the display control in the input display apparatus 201 according to the second embodiment, in which the attribute of the object 212 that is added onto the content 211 which is displayed on the display screen 21 is caused to be the same as the attribute of the content, and the object 212 displayed, will be described with reference to a flowchart.

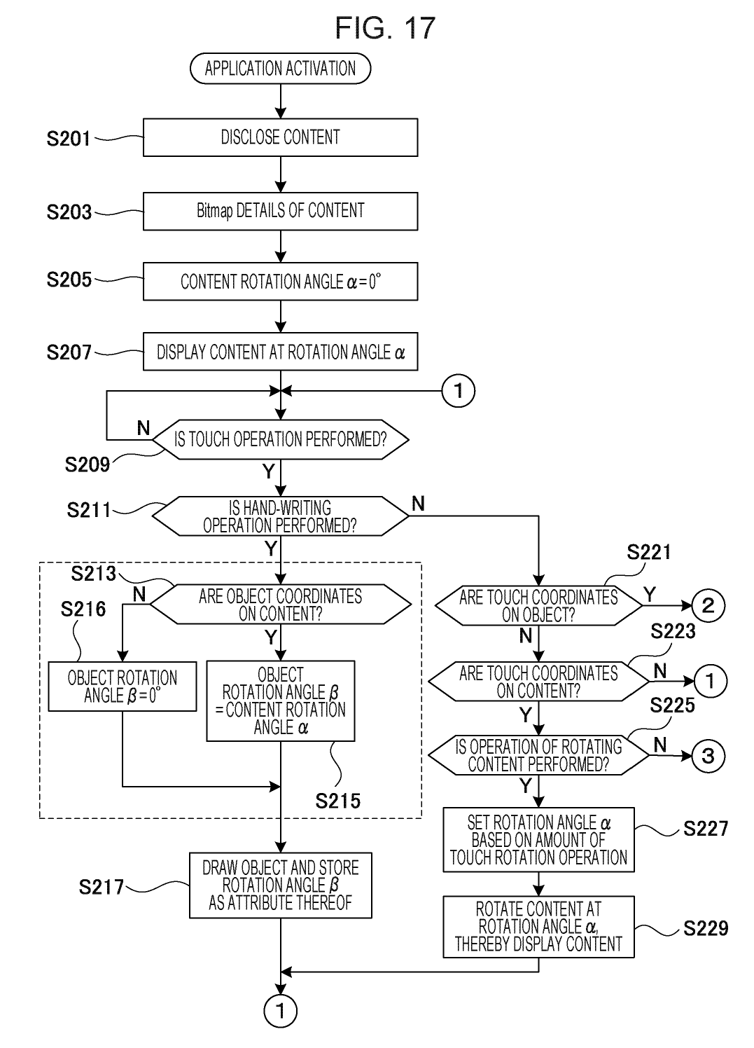

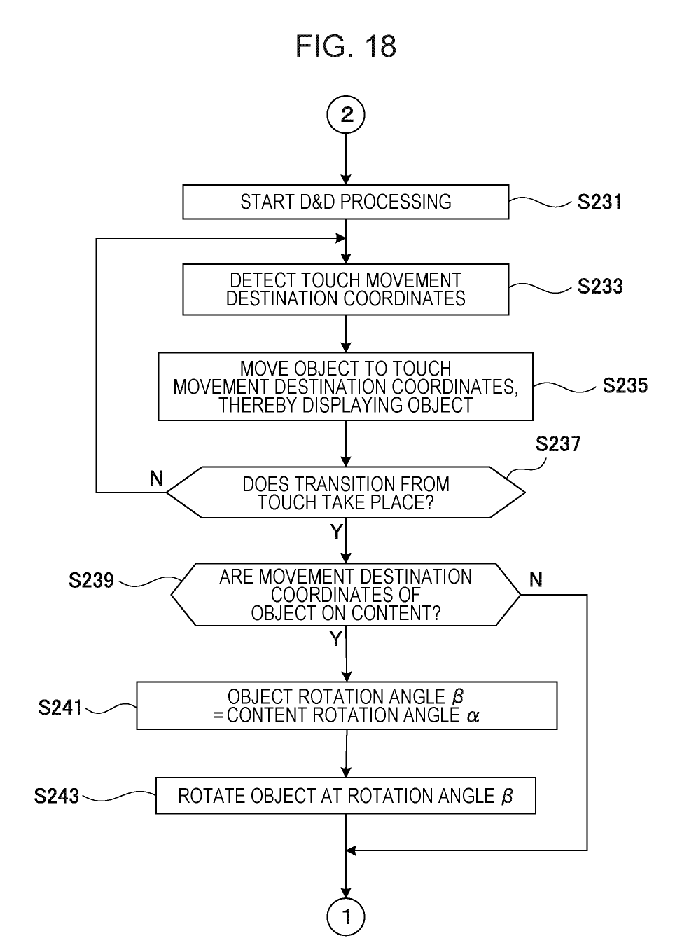

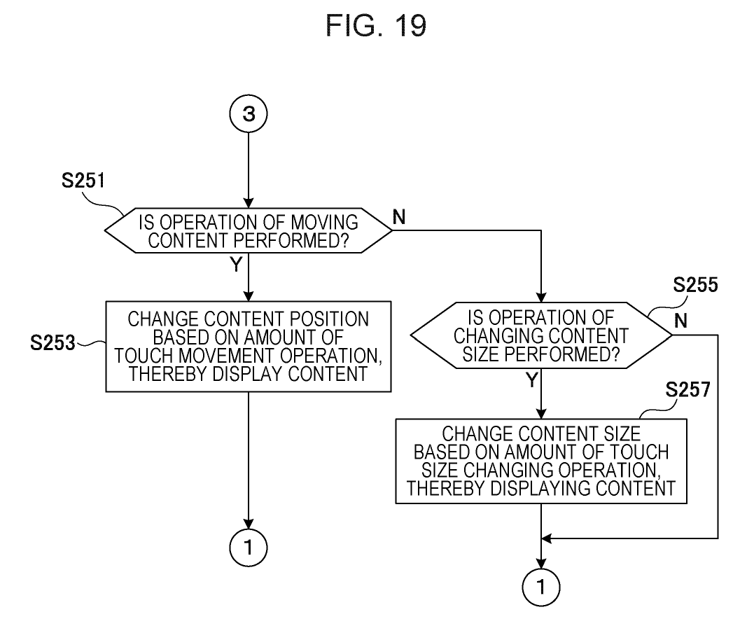

FIG. 17 is a flowchart illustrating a part of the procedure for the display control in which an attribute of the object that is displayed on the display screen in the input display apparatus according to the second embodiment is caused to be the same as an attribute of the content and the object is displayed. FIG. 18 is a flowchart illustrating a part of the procedure for the display control that continues from the flowchart in FIG. 17. FIG. 19 is a flowchart illustrating a part of the procedure for the display control that continues from the flowchart in FIG. 18.

In the input display apparatus 201, as illustrated in FIG. 17, an application that performs the display control is activated and thus specified content is disclosed (Step S201), and details thereof are bitmapped, thereby being displayed in the display screen 21 (Step S203).

The content rotation angle α that is the rotation angle attribute of the content is set to 0° (Step S205), and the content is displayed at a rotation angle of 0° on the display screen 21 (Step S207). Then, it is determined whether or not the operation of gesturing including the touch operation is performed on the display screen (Step S209).

In a case where it is determined in Step S209 that the touch operation (the operation of gesturing) is performed on the display screen, it is determined whether or not the operation is the handwriting operation (Step S211).

In a case where it is determined in Step S211 that the handwriting operation is performed, coordinates of the handwritten object (hereinafter referred to “object”) are on the content (Step S213).

In a case where it is determined in Step S213 that the coordinates of the object are on the content, the object rotation angle β of the object is caused to be the same as the content rotation angle α that is the attribute of the content (Step S215). Then, the object is automatically rotated and thus drawn, and the object rotation angle β is stored as the attribute of the object (Step S217).

On the other hand, in a case where it is determined in Step S213 that the coordinates of the object are not on the content, the object rotation angle β is set to 0° (Step S216), and the object rotation angle β is stored as 0° without automatically rotating the object (Step S217). Then, returning to Step S209 takes place, and it is consecutively determined whether or not the touch operation is performed.

On the other hand, in a case where it is determined in Step S211 that the handwriting operation is not performed, proceeding to Step S221 takes place, and it is determined whether or not the position coordinates at which the touch operation is performed are on the object.

In a case where it is determined in Step S221 that the position coordinates at which the touch operation is performed are not on the object, it is determined whether or not the position coordinates at which the touch operation is performed are on the content (Step S223).

In a case where it is determined in Step S223 that the position coordinates at which the touch operation is performed is on the content, it is determined whether or not the touch operation is the touch operation of rotating the content (Step S225).

In a case where it is determined in Step S225 that the touch operation is the operation of rotating the content, the content rotation angle α is set based on the amount of rotation operation due to the touch operation (hereinafter referred to “amount of touch rotation operation”) (Step S227), and the content is rotated by the rotation angle α, thereby being displayed (Step S229). Then, the returning to Step S209 takes place, and it is consecutively determined whether or not the touch operation is performed on the display screen.

In a case where it is determined in Step S221 that the position coordinates at which the touch operation is performed are on the object, as illustrated in FIG. 18, proceeding to Step S231 takes place, and a drag & drop processing is started. Thus, touch movement destination coordinates are detected (Step S233) and the object is moved to the touch movement destination coordinates, thereby being displayed (Step S235). Then, in a case where it is determined that the transition from the touch state takes place (Step S237), it is determined whether or not the movement destination coordinates of the object is on the content (Step S239).

In a case where it is determined in Step S239 that the movement destination coordinates of the object are on the content, the object rotation angle β is set to be the same as the content rotation angle α (Step S241) and the object is rotated in such a manner as to be the object rotation angle β (Step S243). Then, the returning to Step S209 takes place and it is continuously determined whether or not the touch operation is performed on the display screen.

In a case where it is determined in Step S239 that the movement destination coordinates of the object are not on the content, the returning to Step S209 takes place.

On the other hand, in a case where it is determined in Step S237 that the transition from the touch state does not take place, returning to Step S233 and the touch movement destination coordinates is again detected.

In a case where it is determined in Step S223 that the position coordinates at which the touch operation is performed are not on the content, the returning to Step S209 and it is continuously determined whether or not the touch operation is performed on the display screen.

In a case where it is determined in Step S225 that the touch operation of rotating the content is not performed, as illustrated in FIG. 19, it is determined whether or not the touch operation is the operation of moving the content (Step S251).

In a case where it is determined in Step S251 that the touch operation is the operation of moving the content, the content position is changed based on the amount of touch movement operation, thereby being displayed (Step S253). Then, the returning to Step S209 takes place, and it is consecutively determined whether or not the touch operation is performed on the display screen.

On the other hand, in a case where it is determined in Step S251 that the touch operation is not the operation of moving the content, proceeding to Step S255 takes place and it is determined whether or not the touch operation is the operation of changing the content size.

In a case where it is determined in Step S255 that the touch is the operation of changing the content size, the content size is changed based on the operation of changing the touch size, thereby being displayed (Step S257). Then, the returning to Step S209 takes place, and it is consecutively determined whether or not the touch operation is performed on the display screen.

On the other hand, in a case where it is determined in Step S255 that the touch operation is not the operation of changing the content size, the returning to Step S209, and it is continuously determined whether or not the touch operation is performed on the display screen.

In this manner, in the input display apparatus 201 for the object, with the touch operation (the operation of gesturing), the content and the object that are displayed on the display screen 21 are rotated and are moved and thus may be displayed in the direction in which it is easy for any other user to view the content and the object.

In the second embodiment, when the object 212 is superimposed onto the content 211 that is displayed on the display screen 21, the attribute of the object 212 is caused to be the same as the attribute of the content 211, and thus, only by moving the object 212 onto the content 211, the object 212 can be displayed in the same direction as the content 211 is displayed.

In the second embodiment, when the object 212 is added onto the content 211 that is displayed on the display screen 21, the attribute of the object 212 is caused to be dependent on the attribute of the content 211 and to be the same as the attribute of the content 211, and thus, the object 212 can be automatically rotated in the same direction as the content 211 is displayed, thereby being displayed, without performing the operation of gesturing.

Since the configuration described above is employed, according to the second embodiment, in the input display apparatus 201, when the object 212 is added by the second display processing unit 42 onto an area for displaying the content 211, the attribute for displaying the object 212 is caused, by the second display processing unit 42, to be dependent on the attribute for displaying the content 211 and thus the object 212 is displayed with the same the attribute as the content 211. Because of this, for example, only by adding the object 212 onto the content 211 that is displayed in alignment with the direction of the counterpart user, the object 212 can be automatically rotated in the same direction as the content 211, thereby being displayed.

### Third Embodiment

Next, a third embodiment will be described with reference to the drawings.

It is noted that for the convenience of description, a configuration that has the same function as in the first embodiment is given the same reference numeral and a description thereof is omitted.

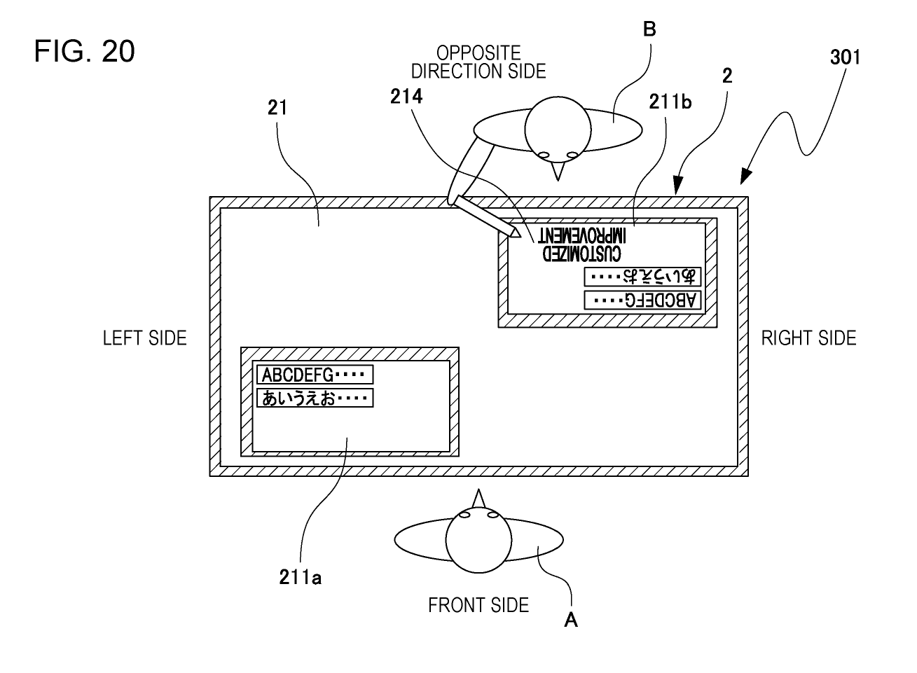

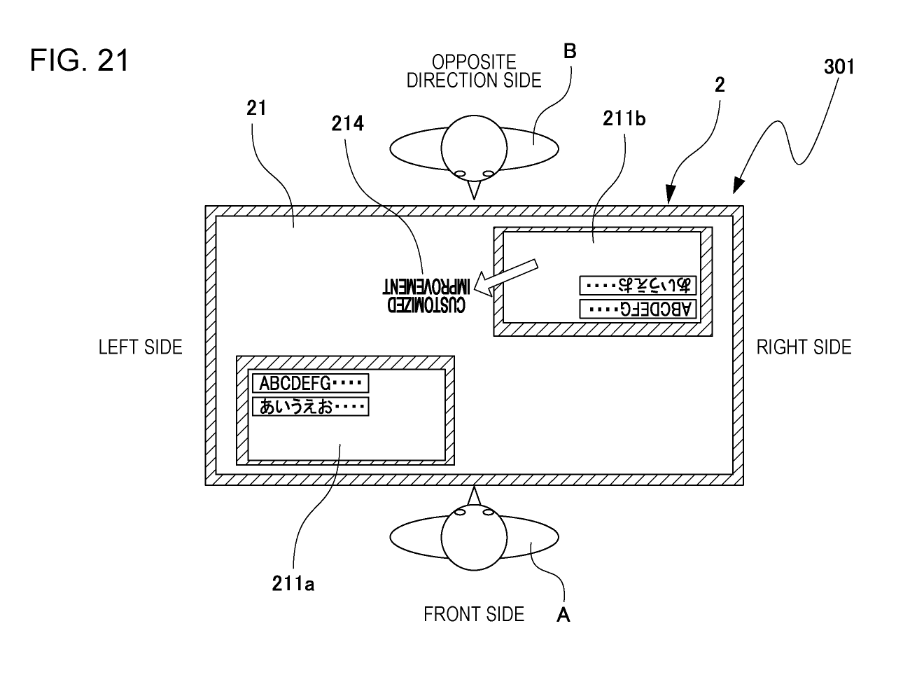

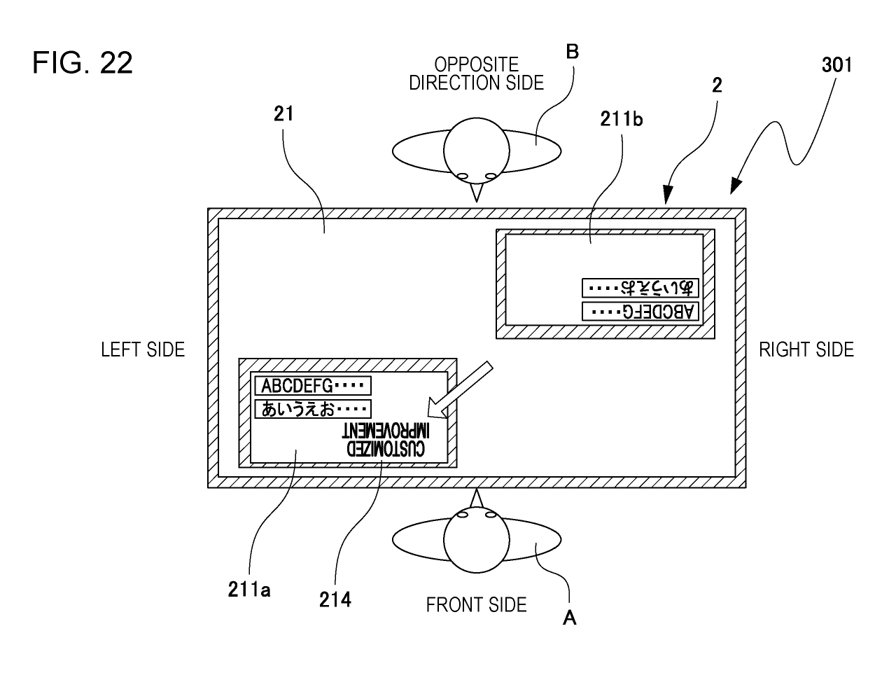

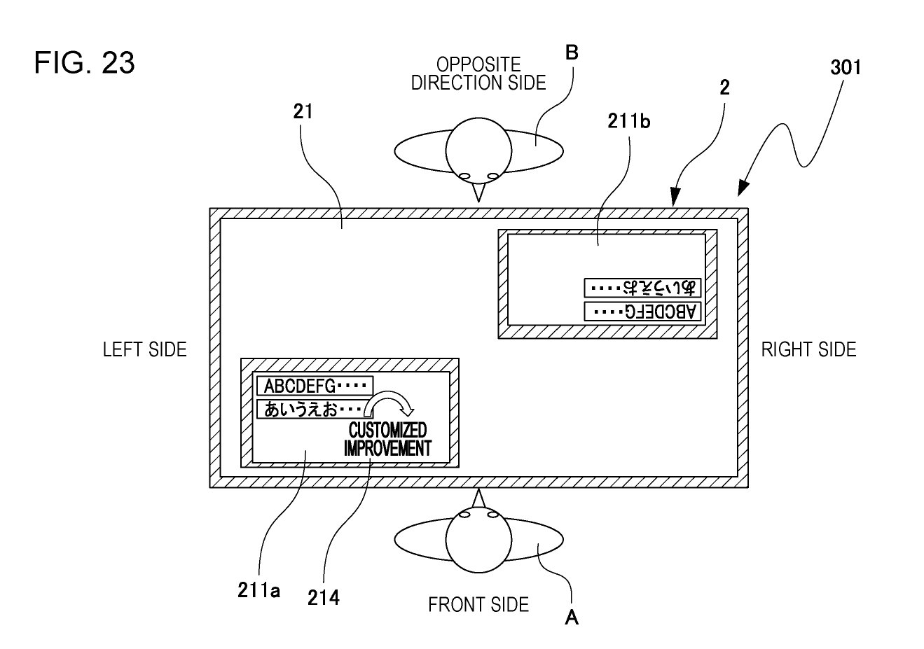

FIG. 20 is a descriptive diagram illustrating an example in which multiple items of content that are display-controlled on a display screen in an input display apparatus according to the third embodiment and an object are displayed. FIG. 21 is a descriptive diagram illustrating a state where an object is separated from an area for displaying content B, among the multiple items of content and the object is moved to an area other than the area for displaying the content B. FIG. 22 is a descriptive diagram illustrating a state where the object is moved to an area for displaying content A. FIG. 23 is a descriptive diagram illustrating a state where the object is display-controlled on the area for displaying the content A.

When as illustrated in FIG. 20, as the function of the second display processing unit 42, an object 214 is separated from an area for displaying content B211b that is display-controlled on the display screen 21 and thus is moved to an area for displaying a separate item of content A211a, the input display apparatus 301 according to the third embodiment causes the attribute of the object 212 to be the same as an attribute of the content A211a and thus displays the object 212.

In FIG. 20, the input display apparatus 301 is used by the user A who directly faces the display screen 21 and the user B on the opposite direction side, the content B 211b and the content A 211a are displayed, in the direction that is opposite the user B and in the direction that is opposite the user A, respectively, on the display screen 21.

The content B211b has an attribute that is the content rotation angle α which is set to 180°, in such a manner as to be in a direction in which it is easy for the user B on the opposite direction side to view the content B211b. The content A211a has an attribute that is the content rotation angle α which is set to 0°, in such a manner as to be in a direction in which it is easy for the user A on the front side to view the content A211a.

The object 214 is added by the user B onto the area for displaying the content B 211b in such a manner as to be superimposed onto the content B211b. By being drawn on the content B211b, the object 214 has the same attribute as the content B211b, that is, an attribute that is the object rotation angle β which is set to 180°.

When the object 214, as illustrated in FIG. 21, is moved to a location at a distance away from the area for displaying the content B211b, the object 214 is displayed with an attribute that is set when the object 214 is added, that is, with an attribute that is the object rotation angle β which is set to 180°.

When the object 214, as illustrated in FIG. 22, is moved to the area for displaying the content A211a, the attribute of the object 214, as illustrated in FIG. 23, is caused to be the same as an attribute of the content A211a, and thus the object 214 is displayed with an attribute that is the object rotation angle β which is set to 0°, which is the same as the content rotation angle α.

Since the configuration described above is employed, according to the third embodiment, in the input display apparatus 301, when, as the function of the second display processing unit 42, the object 214 is separated from the area for displaying the content B211b that is display-controlled on the display screen 21 and is moved to the area for displaying the content A211a, the attribute of the object 214 is caused to be dependent on the attribute of the content A211a and thus the object 214 is displayed with the same attribute as the content A211a. Because of this, only by moving the object 214 between the content B211b and the content A211a, the object 214 can be displayed, in the same direction as the content that is a movement destination, on the area for displaying the content that is the movement destination.

Moreover, as a modification example of the third embodiment, for example, as illustrated in FIGS. 22 and 23, in a case where the user B on the opposite direction side delivers the object 214 one time to the user A on the front side, the object 214 is moved back to the content B211b on the opposite direction side, and thus, as illustrated in FIG. 20, the attribute can return to its original state and the object 214 can be set to face the user B.

### Fourth Embodiment

Next, a fourth embodiment will be described with reference to the drawings.

It is noted that for the convenience of description, a configuration that has the same function as in the first embodiment is given the same reference numeral and a description thereof is omitted.

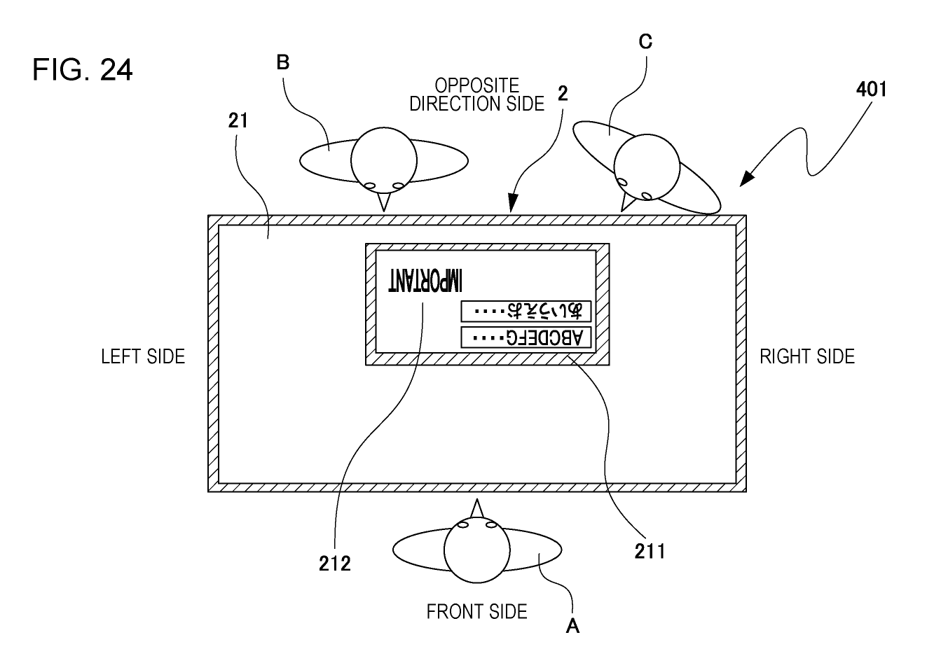

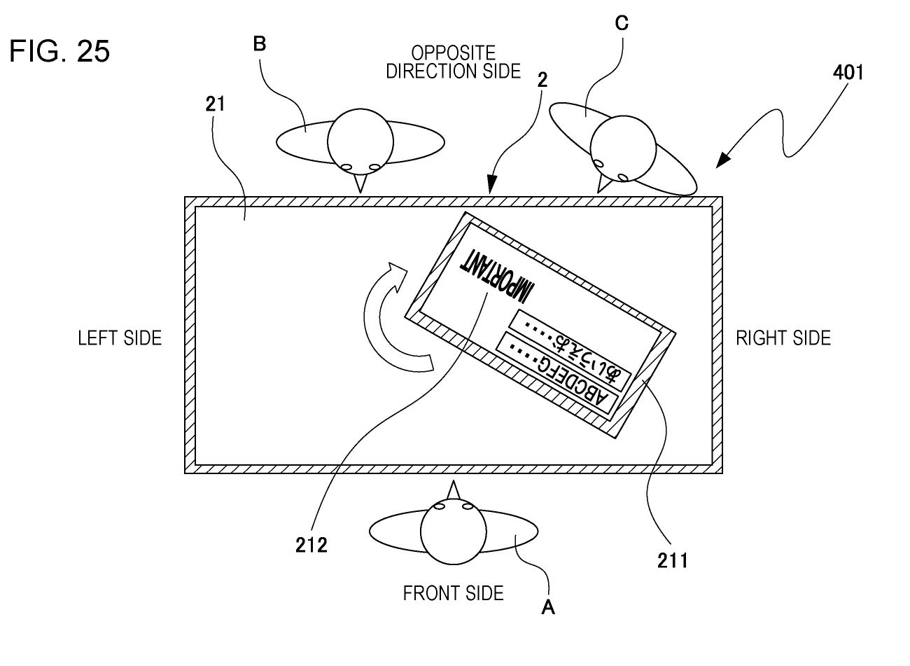

FIG. 24 is a descriptive diagram illustrating an example in which content that is display-controlled on a display screen in an input display apparatus according to the fourth embodiment and an object that is superimposed on the content are composited and a result of the compositing is displayed. FIG. 25 is a diagram illustrating an example in which an operation of rotating the content that is compositely combined with the object is performed and thus the result of the compositing is displayed.

When as illustrated in FIG. 24, as the function of the first display processing unit 41, the object 212 is superimposed on the content 211 that is displayed on the display screen 21 and thus is displayed, the input display apparatus 401 according to the fourth embodiment composites the content 211 and the object 212 and thus displays a result of the compositing.

In FIG. 24, the input display apparatus 401 is used by the user A who directly faces the display screen 21, the user B on the opposite direction side, and the user C on the inclined right side, and the object 212 is displayed on the display screen 21, in a state of being superimposed onto the content 211.

The content 211 has an attribute that is the content rotation angle α which is set to 180°, in such a manner that it is easy for the user B on the opposite direction side to view the content 211.

In the fourth embodiment, for positioning, the object 212 is superimposed onto the content 211, and thus the object 212 and the content 211 are composited by the first display processing unit 41, and thus the object 212 is displayed as a portion of the content 211.

For example, in a case where the direction in which it is easy for the user C on the inclined right side to view the object 211 is set, as illustrated in FIG. 25, the operation of gesturing is performed on the content 211 in such a manner that the content 211 is in a direction that faces the user C. At this time, the object 212 rotates in a state of being integrally combined with the content 211. In this manner, because of the function of the first display processing unit 41, the object 212 that is added onto the content 211 and the content 211 are composited, and thus the object 212 is displayed in a composited state.

Because the object 212 and the content 211 are composited, for example, even in a case where a size enlargement or reduction operation is performed on the content 211, the size enlargement or reduction operation is performed on the object 212 in a state of being integrally combined with the content 211.

Since the configuration described above is employed, according to the fourth embodiment, in the input display apparatus 401, when the content 211 and the object 212 are superimposed on each other on the display screen 21, the content 211 and the object 212 are composited by the first display processing unit 41 and the object 212 is displayed as a portion of the content 211. Accordingly, only by moving and thus superimposing the object 212 onto the content 211, the content 211 and the object 212 can be simply composited. Because of this, the content 211 and the object 212 can be rotated and moved in an integrated manner.

### Fifth Embodiment

Next, a fifth embodiment will be described with reference to the drawings.

It is noted that for the convenience of description, a configuration that has the same function as in the first embodiment is given the same reference numeral and a description thereof is omitted.

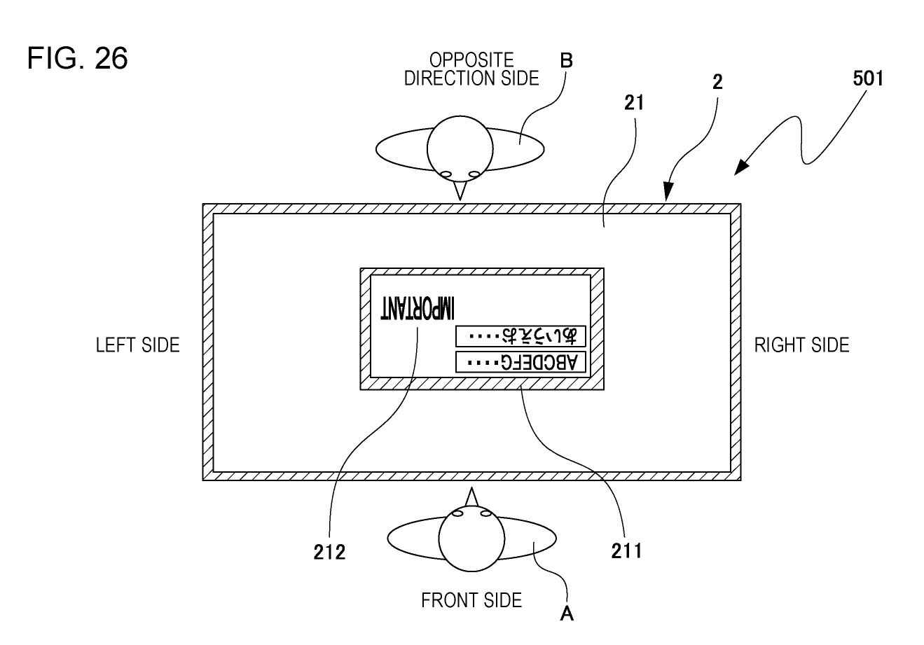

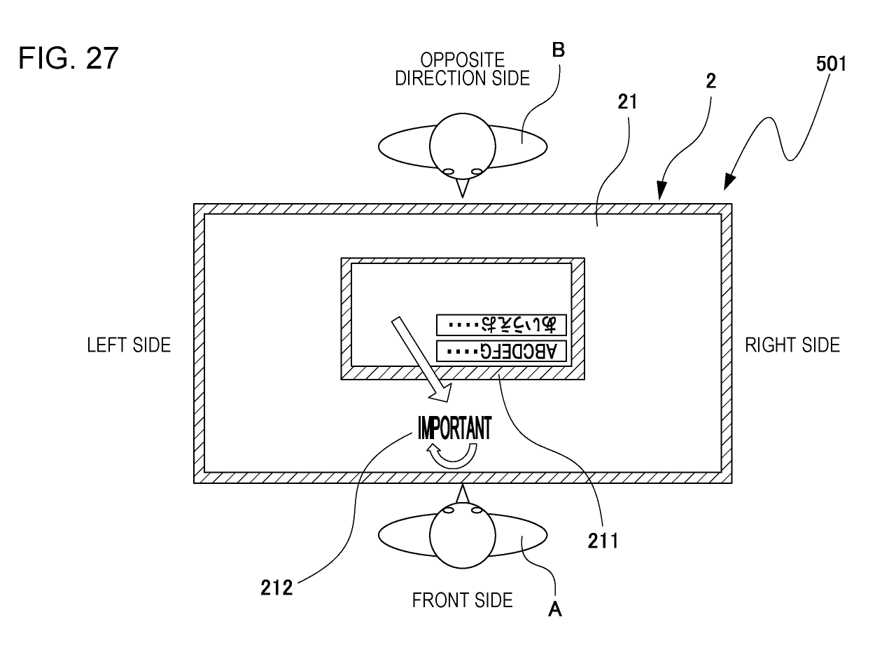

FIG. 26 is a descriptive diagram illustrating an example in which content that is display-controlled on a display screen in an input display apparatus according to the fifth embodiment and an object on an area for displaying the content are displayed. FIG. 27 is a descriptive diagram illustrating a state where the object that is displayed on the area for displaying the content is separated from the content and thus is displayed.

When, as the function of the second display processing unit 42, the object is separated from the area for displaying the content that is display-controlled on the display screen 21, an input display apparatus 501 according to the fifth embodiment causes an attribute of the object that was caused to be the same as an attribute of the content, to return to its original attribute, and thus displays the object.

In FIG. 26, the input display apparatus 501 is used by the user A who directly faces the display screen 21 and the user B on the opposite direction side, and the object 212 is displayed on the area for displaying the content 211 that is displayed on the display screen 21. The content 211 has an attribute that is the rotation angle of 180° in such a manner that it is easy for the user B on the opposite direction side to view the content 211.

At this point, for example, the object 212, when displayed on the display screen 21 for the first time, has an attribute that is the object rotation angle β which is set to 0, but the attribute of the object 212 is caused to be the same as the attribute of the content 211 and the object 212 is displayed on the area for displaying the content 211.

In the fifth embodiment, when the object 212 is separated from the area for displaying the content 211, because of the function of the second display processing unit 42, the attribute of the object that was caused to be the same as the attribute of the content 211 is caused to return to its original attribute and thus the object is displayed.

Specifically, the object 212, as illustrated in FIG. 26, has an attribute of 180° in such a manner that, on the area for displaying the content 211, the object rotation angle β is the same as the content rotation angle α of the content 211 in terms of the attribute.

Thus, as illustrated in FIG. 27, when the object 212 is removed from the area for displaying the content 211, for example, when the object 212 is positioned in front of the user A on the front side, the attribute of the object 212 is caused to return to its original attribute that is the object rotation angle β which is set to 0°, and thus the object 212 is displayed in the direction that is opposite the user A.

Since the configuration described above is employed, according to the fifth embodiment, in the input display apparatus 501, when the object 212 is separated from the area for display-controlling the content 211 on the display screen 21, the dependence on the attribute of the content 211 is canceled, and the attribute of the object 212 is caused to return to its original attribute and thus the object 212 is displayed. Because of this, the rotation or the movement can be again freely performed.

### Sixth Embodiment

Next, a sixth embodiment is described.

It is noted that for the convenience of description, a configuration that has the same function as in the first embodiment is given the same reference numeral and a description thereof is omitted.

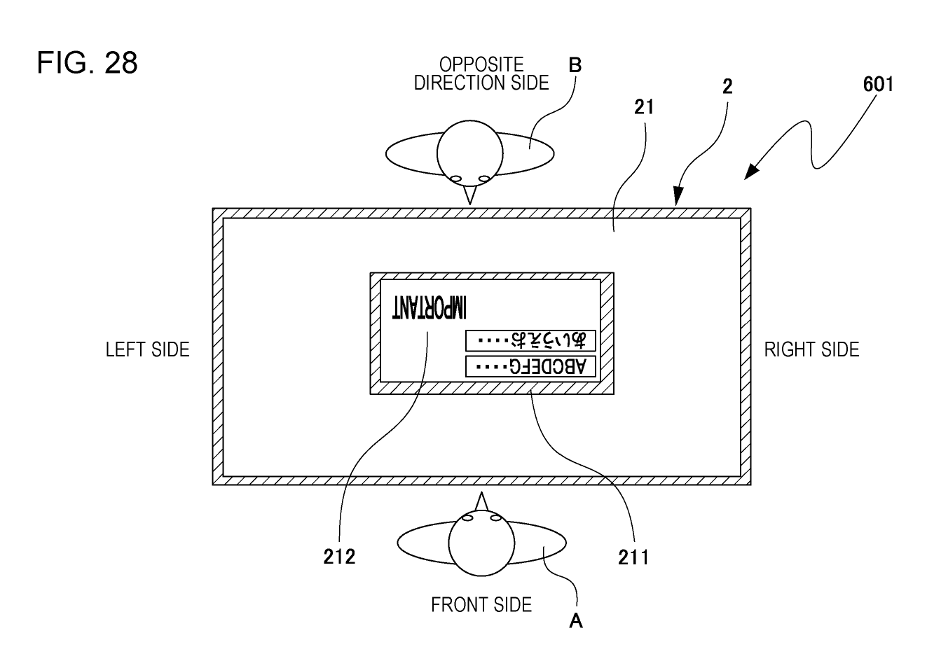

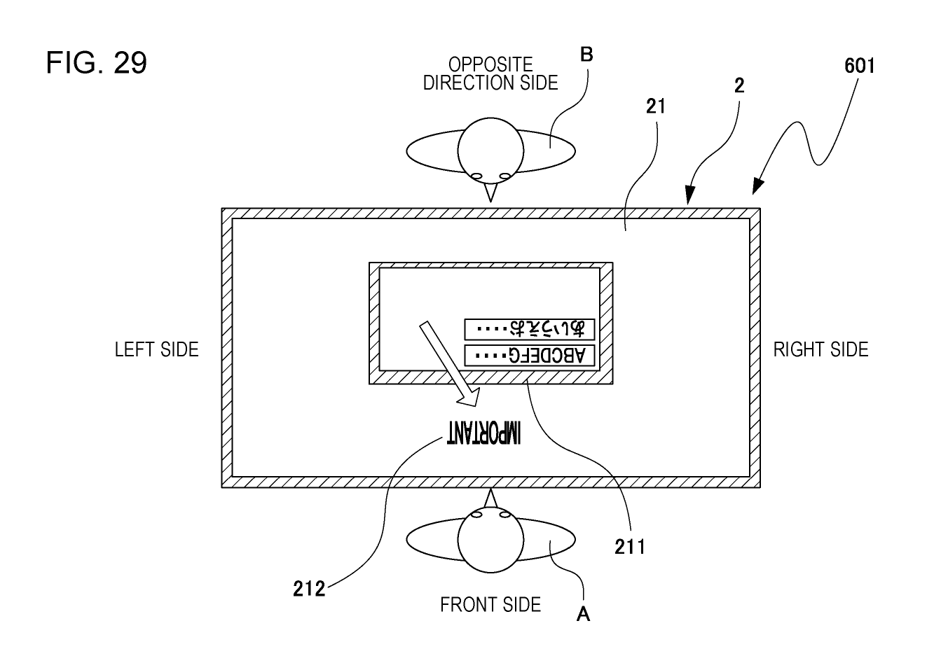

FIG. 28 is a descriptive diagram illustrating an example in which content that is display-controlled on a display screen in an input display apparatus according to the sixth embodiment and an object on an area for displaying the content are displayed. FIG. 29 is a descriptive diagram illustrating a state where the object that is displayed on the area for displaying the content is separated from the content and thus is displayed.

Since the configuration described above is employed, when, as the function of the second display processing unit 42, in addition to the function in the input display apparatus 1 according to the first embodiment, the object is separated from the area for displaying the content that is display-controlled on the display screen 21, an input display apparatus 601 according to the sixth embodiment maintains the attribute that is the same as the attribute of the content and thus displays the object.

In FIG. 28, the input display apparatus 601 is used by the user A who directly faces the display screen 21 and the user B on the opposite direction side, and the object 212 is displayed on the area for displaying the content 211 that is displayed on the display screen 21. The content 211 has an attribute that is the rotation angle of 180° in such a manner that it is easy for the user B on the opposite direction side to view the content 211.

At this point, for example, the object 212, when displayed on the display screen 21 for the first time, has an attribute that is the object rotation angle β which is set to 0, but the attribute of the object 212 is caused to be the same as the attribute of the content 211 and the object 212 is displayed on the area for displaying the content 211.

In the sixth embodiment, when the object 212 is separated from the area for displaying the object 211, because of the function of the second display processing unit 42, the object 212 is displayed in a state where the attribute that was caused to the same as the attribute of the content 211 is maintained as is.

Specifically, the object 212, as illustrated in FIG. 28, has an attribute of 180° in such a manner that, on the area for displaying the content 211, the object rotation angle β is the same as the content rotation angle α of the content 211.

Thus, as illustrated in FIG. 29, when the object 212 is removed from the area for displaying the content 211, for example, when the object 212 is positioned in front of the user A on the front side, the object 212 is displayed in a direction that is opposite to the user A, in a state where the attribute of the object 212 still remains an attribute that is the object rotation angle β which is set to 180°.

Since the configuration described above is employed, according to the sixth embodiment, in the input display apparatus 601, when the object 212 is separated from the area for displaying the content 211 that is display-controlled on the display screen 21, without the dependence of the attribute of the content 211 being canceled, the object 212 is set to be displayed in a state where the attribute of the object 212 is caused to be dependent on the attribute of the content. Because of this, the dependent state of the object 212 can be maintained until is again caused to be dependent on any other content, and the object 212 can be displayed in association with the content 211.

It is noted that in the function of the second display processing unit 42, in which the attribute of the object is caused to be dependent on the attribute of the content, switching is possible between selectively causing and canceling the dependency of the attribute of the object on the attribute of the content.

### Seventh Embodiment

Next, a seventh embodiment will be described.

It is noted that for the convenience of description, a configuration that has the same function as in the first embodiment is given the same reference numeral and a description thereof is omitted.

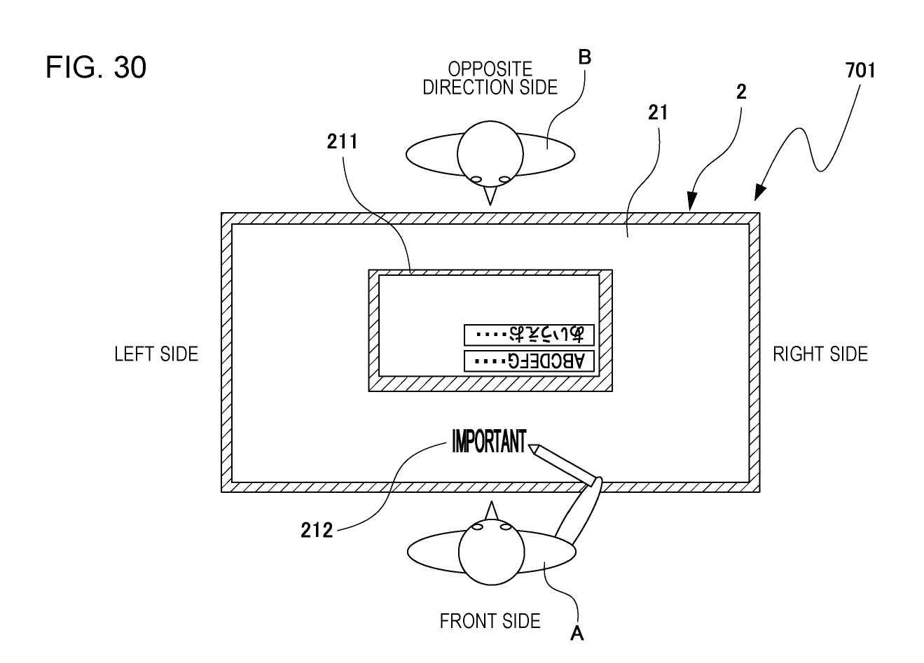

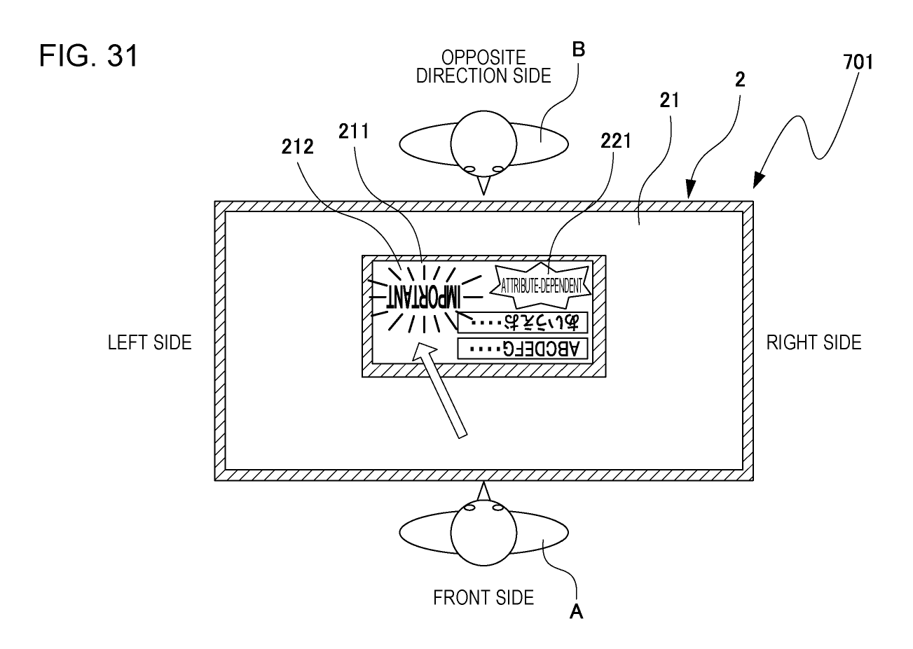

FIG. 30 is a descriptive diagram illustrating a state where the user writes an object on a display screen in an input display apparatus according to the seventh embodiment. FIG. 31 is a descriptive diagram illustrating a state where the object is moved onto content on the display screen.

When, as the function of the second display processing unit 42, in addition to the function in the input display apparatus 1 according to the first embodiment, the object 212 is moved and thus is superimposed onto the content 211, an input display apparatus 701 according to the seventh embodiment displays the object 212 in an identified manner.

For example, when, as illustrated in FIGS. 30 and 31, the display screen 21 of the input display apparatus 701, the object 212 that is drawn by the user A on the front side is moved onto the content 211 that is displayed in such a manner as to be opposite the user B on the opposite direction side, in a case where the attribute of the object 212 is caused to be dependent on the attribute of the content 211, the object 212 may flash on and off.

Since the configuration described above is employed, according to the seventh embodiment, when the object 212 is superimposed onto the content 211, in a case where the attribute of the content 211 is caused to be dependent on the attribute of the object 212, the object 212 is set to be displayed in an identified manner. Thus, it can be easily recognized that the attribute of the object 212 that is added is in a dependent state.

When the attribute of the object 212 is in a state of being dependent on the attribute of the content 211, a shortcut mark 221 or the like indicating that the attribute of the object 212 is in a state of being dependent on the attribute of the content 211 may be displayed on the display screen 21.

In a case where the attribute of the object 212 is in a state of being dependent on the attribute of the content 211, although the object 212 is in a state of being separated from the content 211, the attribute-dependent state may be maintained.

It is noted that, when the state of being dependent on the attribute of content 211 is canceled, a prescribed operation, for example, a cancellation operation, such as an operation of touching on the shortcut mark, may be performed.

### Eighth Embodiment

Next, an eighth embodiment will be described. In the embodiments described above, the object 212 is moved on the content 211 or the object 212 is drawn in such a manner as to be superimposed onto the content 211, and thus the attribute of the object 212 is caused to be dependent on the attribute of the content 211. However, a relationship between the attribute of the content 211 and the attribute of the added object 212 is not limited to this.

In the eighth embodiment, for example, the content is moved in such a manner as to be superimposed onto the object that is drawn on the display screen and thus is displayed. Thus, the attribute of the content may be caused to be dependent on the attribute of the object that is already drawn.

As another example, a separate object is moved in such a manner as to be superimposed onto the object that is drawn on the display screen, or is drawn, and thus an attribute of the separate object may be caused to be dependent on the attribute of the object that is already drawn.

Moreover, as still another example, a separate content is displayed in such a manner as to be superimposed onto the content that is drawn on the display screen, and thus an attribute of the separate content may be caused to be dependent on an attribute of the content that is already displayed.

With the configuration described above, according to the eighth embodiment, the attribute of the content or the object is suitably caused to be dependent on each other, it is possible that the content or the object is integrally displayed.

### Ninth Embodiment

Next, a ninth embodiment will be described.

It is noted that for the convenience of description, a configuration that has the same function as in the first embodiment is given the same reference numeral and a description thereof is omitted.

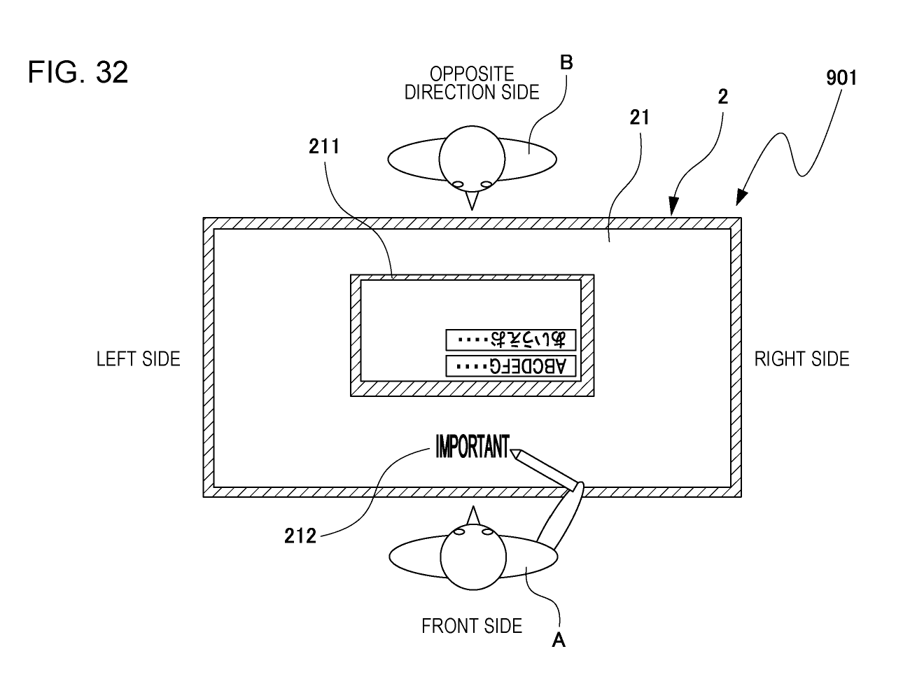

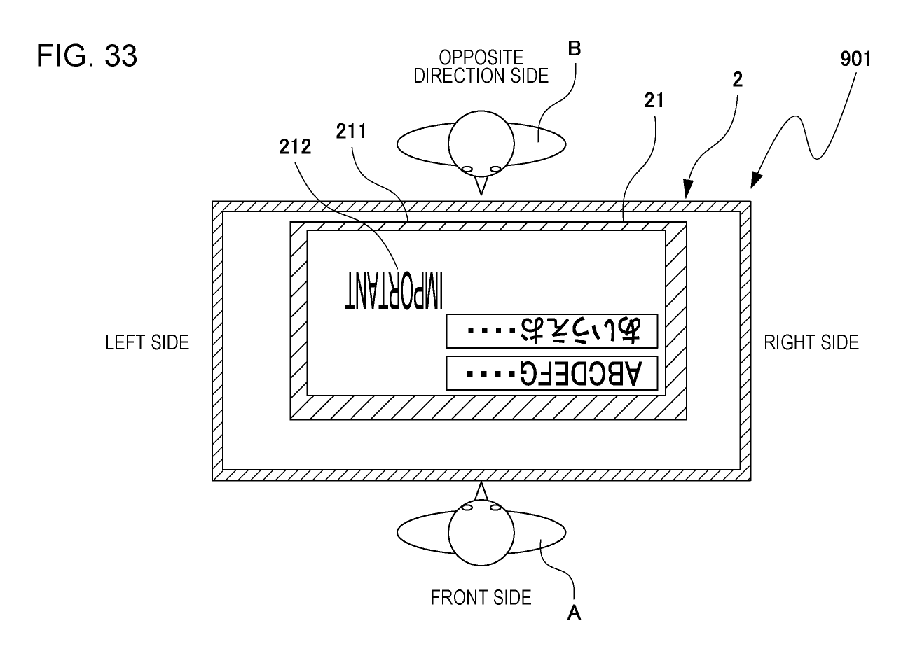

FIG. 32 is a descriptive diagram illustrating a state where the user writes an object on a display screen in an input display apparatus according to the ninth embodiment. FIG. 33 is a descriptive diagram illustrating a state where, on the display screen, an attribute of the object is caused to be dependent on an attribute of content and thus the object is displayed in an enlarged manner.

In the embodiments described above, the object 212 is moved on the content 211 or the object 212 is drawn in such a manner as to be superimposed onto the content 211, and thus, with a rotation angle information on the content 211 being set as the attribute, the attribute of the object 212 is caused to be dependent and thus is displayed. However, the attributes of the content 211 and the object 212 are not limited to this.

In an input display apparatus 901 according to the ninth embodiment, an enlargement ratio or a reduction ratio for displaying the content 211 is set as a size attribute, and a size attribute of the object 212 is caused to be dependent on a size attribute of the content 211 and thus the object 212 is displayed.

For example, as illustrated in FIG. 32, on the display screen 21 of the input display apparatus 901, the object 212 that is drawn by the user A on the front side is displayed in such a manner as to be opposite the user B on the opposite direction side, and thus, for positioning, the object 212 is moved in such a manner as to be superimposed onto the content 211. In this state, as illustrated in FIG. 33, when the content 211 is displayed in an enlarged manner, the object 212 is caused to be dependent on the attribute of the content 211 and thus likewise, the object 212 is also displayed in an enlarged manner.

Since the configuration described above is employed, according to the ninth embodiment, in the input display apparatus 901, in a state where, for positioning, the object 212 is moved in such a manner as to be superimposed onto the content 211, when an enlargement or reduction operation is performed on the content 211, the attribute of the object 212 can be caused to be dependent onto the attribute of the content 211 that is the enlargement ratio or the reduction ratio, and thus, likewise, the object can also be displayed in an enlarged or reduced manner.

It is noted that it is possible that, as the attributes of the content 211 and the object 212, in addition to the size described above, a transmittance, a layered structure (display on the rear surface, or the like) and the like are set as attributes. The attribute of the content 211 or the object 212 may be caused to be dependent and may be wholly caused to be selectively dependent.

### Tenth Embodiment

Next a tenth embodiment will be described.

In the first embodiments described above, on the display screen, for positioning, the object is moved onto the content, and thus is caused to be dependent on the attribute of the content and thus the object is displayed. However, with any other method, the attribute of the object may be caused to be dependent on the attribute of the content.

In the tenth embodiment, for example, a touch operation is performed on the content and the object on the display screen at the same time, and thus the attribute of the content and the attribute of the object may be caused to be dependent on each other. Alternatively, a swipe operation is performed on the object in the direction of the content, and thus the attribute of the content and the attribute of the object may be caused to be dependent on each other.

As described above, the present disclosure is not limited to the embodiments described, and it is possible that various changes are made in the scopes of the disclosure that are claimed in claims. It is apparent to a person of ordinary skill in the art that various change examples and modification examples are contemplated in the scope of the disclosure that are claimed in claims, that is, embodiments that are obtained by combining technical means that results from making suitable changes in the scope that does not depart from the gist of the present disclosure also fall within the scope of the present disclosure.

The present disclosure contains subject matter related to that disclosed in Japanese Priority Patent Application JP 2018-008936 filed in the Japan Patent Office on Jan. 23, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An input display apparatus that possibly displays content, comprising:
a display unit on which multiple items of content are displayed;
a detection unit that detects an operation on first content among the multiple items of content that are displayed on the display unit; and
a display processing unit that causes an attribute of the first content to be dependent on an attribute of second content, in a case where an operation of moving or adding the first content onto the second content is detected by the detection unit.

2. The input display apparatus according to claim 1,
wherein the display processing unit composites the first content and the second content and thus displays a result of the compositing, when an operation of superimposing the first content onto the second content is detected by the detection unit.

3. The input display apparatus according to claim 2,
wherein the display processing unit causes the attribute of the first content to return the pre-superimposition attribute and thus displays the first content, when an operation of separating the first content from an area for displaying the second content is detected by the detection unit.

4. The input display apparatus according to claim 1,
wherein the attribute includes at least either display magnification or a rotation angle.

5. An input display method in an input display apparatus that possibly displays content, the method comprising:
displaying multiple items of content;
detecting an operation on first content among the multiple items of content that are displayed; and
performing display processing that causes an attribute of the first content to be dependent on an attribute of second content, in a case where an operation of moving or adding the first content onto the second content is detected.

6. A non-transient recording medium on which a program that causes an input display apparatus which possibly displays content to operate is stored, the program causing a computer to:
display multiple items of content;
detect an operation on first content among the multiple items of content that are displayed; and
perform display processing that causes an attribute of the first content to be dependent on an attribute of second content, in a case where an operation of moving or adding the first content onto the second content is detected.
